(19) United States
(12) Patent Application Publication
(10) Pub. No.: US 2020/0013520 A1
(43) Pub. Date: Jan. 9, 2020

(54) CONDUCTIVE MATERIAL, AND CONNECTION STRUCTURE

(71) Applicant: SEKISUI CHEMICAL CO., LTD., Osaka-city, Osaka (JP)

(72) Inventors: Takashi Kubota, Kouka-city, Shiga (JP); Keizo Nishioka, Inukami-gun, Shiga (JP)

(21) Appl. No.: 16/491,074

(22) PCT Filed: Mar. 20, 2018
(86) PCT No.: PCT/JP2018/011067

§ 371 Date: Sep. 4, 2019

(30) Foreign Application Priority Data
Mar. 23, 2017 (JP) 2017-057629
Mar. 23, 2017 (JP) 2017-057630
Mar. 23, 2017 (JP) 2017-057631

(51) Int. Cl. H01B 1/22; H01R 4/02; H01R 4/04; C08K 3/11; C08K 5/3475; C08K 5/47

(52) U.S. Cl. CPC H01B 1/22; H01R 4/02; H01R 4/04; C08K 2201/001; C08K 5/3475; C08K 5/47; C08K 3/11

(57) ABSTRACT

The present invention provides a conductive material in which, even when the conductive material is left for a certain period of time, solder can efficiently placed on an electrode, and, in addition, wettability of the solder can be improved.

The conductive material according to the present invention contains a thermosetting compound and a plurality of solder particles, and the concentration of free tin ions in the conductive material is 100 ppm or less.

### TECHNICAL FIELD

The present invention relates to a conductive material containing solder particles. The present invention also relates to a connection structure using the conductive material.

### BACKGROUND ART

Anisotropic conductive materials such as anisotropic conductive paste and anisotropic conductive films are widely known. In the anisotropic conductive material, conductive particles are dispersed in a binder.

The anisotropic conductive material is used to obtain various connection structures. Examples of connection using the anisotropic conductive material include a connection between a flexible printed board and a glass substrate (FOG (Film on Glass)), a connection between a semiconductor chip and a flexible printed board (COF (Chip on Film)), a connection between a semiconductor chip and a glass substrate (COG (Chip on Glass)), and a connection between a flexible printed board and a glass epoxy board (FOB (Film on Board)).

For example, when an electrode of a flexible printed board and an electrode of a glass epoxy board are electrically connected by the anisotropic conductive material, the anisotropic conductive material containing conductive particles is placed on the glass epoxy board. Then, the flexible printed board is stacked to be heated and pressurized. Thereby, the anisotropic conductive material is cured to electrically connect the electrodes via the conductive particles, and thus to obtain the connection structure.

The conductive materials such as the above anisotropic conductive material are disclosed in the following Patent Documents 1 to 3.

The following Patent Document 1 describes an anisotropic conductive material containing conductive particles and a resin component which is not completely cured at the melting point of the conductive particles. Specific examples of the conductive particles include metals such as tin (Sn), indium (In), bismuth (Bi), copper (Cu), zinc (Zn), lead (Pb), cadmium (Cd), gallium (Ga), silver (Ag) and thallium (Tl), and alloys of these metals.

Patent Document 1 describes that electrodes are electrically connected through a resin heating step in which an anisotropic conductive material is heated to a temperature which is higher than the melting point of the conductive particles and at which the resin component is not completely cured, and a resin component curing step in which the resin component is cured. In addition, Patent Document 1 describes that mounting is performed according to the temperature profile shown in FIG. 8. In Patent Document 1, the conductive particles are melted in the resin component, which is not completely cured, at a temperature at which the anisotropic conductive material is heated.

The following Patent Document 2 discloses an adhesive tape (conductive material) including a resin layer containing a thermosetting resin, a solder powder, and a curing agent, and in this adhesive tape, the solder powder and the curing agent reside in the resin layer.

The following Patent Document 3 discloses an anisotropic conductive film in which conductive particles are dispersed in an insulating adhesive. A free ion concentration in the anisotropic conductive film is 60 ppm or less. In Patent Document 3, halogen ions such as chlorine, sodium ions, and potassium ions are described as free ions.

### RELATED ART DOCUMENTS

### Patent Documents

Patent Document 1: JP 2004-260131 A

Patent Document 2: WO 2008/023452 A1

Patent Document 3: JP H9-199207 A

### SUMMARY OF THE INVENTION

### Problems to be Solved by the Invention

In the conventional conductive materials as described in Patent Documents 1 to 3, the moving speed of the conductive particles or the solder particles onto the electrode (line) is slow, and in some cases, the conductive particles or the solder particles may be unable to be efficiently arranged between upper and lower electrodes to be connected. In particular, when the conductive material is placed on a substrate or the like and then left for a long time, the conductive material is thickened, so that the solder may hardly aggregate on the electrode in some cases. As a result, conduction reliability between the electrodes may be low in the conventional conductive materials.

In recent years, mounting on a small electrode having a small electrode width and a small inter-electrode width has been carried out, and reduction of the particle diameter of the conductive particles or the solder particles is required. In the conventional conductive materials as described in Patent Documents 1 to 3, oxidation of the surface of solder of the conductive particles or the solder particles proceeds with the reduction of the particle diameter of the conductive particles or the solder particles, so that wettability of the solder may deteriorate. In the conventional conductive materials, a limit exists for coping with a reduction in pitch between electrodes.

Further, in the conventional conductive materials, the conductive particles or the solder particles tend to be oxidized, and impact resistance of a connection portion between the electrodes to be connected may be unable to be sufficiently enhanced in some cases. In particular, in a substrate or the like after mounting using a conductive material, when the impact resistance of the connection portion is not sufficiently high, the connection portion may crack due to impact such as falling of the substrate. As a result, it is difficult to sufficiently increase the conduction reliability between the electrodes.

As a method for enhancing the impact resistance of the connection portion, there can be mentioned a method using SAC (tin-silver-copper) alloy particles instead of the conventional conductive particles or solder particles. However, the SAC particles have a melting point of 200° C. or more, and it is thus difficult for the SAC particles to be mounted at a low temperature.

It is an object of the present invention to provide a conductive material in which, even when the conductive material is left for a certain period of time, solder can be efficiently placed on an electrode, and, in addition, wettability of the solder can be improved. It is also an object of the present invention to provide a connection structure using the conductive material.

### Means for Solving the Problems

According to a broad aspect of the present invention, there is provided a conductive material containing a thermosetting compound and a plurality of solder particles, and the conductive material has the concentration of free tin ions of 100 ppm or less.

In a specific aspect of the conductive material according to the present invention, the conductive material contains an ion scavenger.

In a specific aspect of the conductive material according to the present invention, the ion scavenger contains zirconium, aluminum or magnesium.

In a specific aspect of the conductive material according to the present invention, the particle diameter of the ion scavenger is 10 nm or more and 1000 nm or less.

In a specific aspect of the conductive material according to the present invention, the content of the ion scavenger in 100% by weight of the conductive material is 0.01% by weight or more and 1% by weight or less.

In a specific aspect of the conductive material according to the present invention, the conductive material contains a compound having a benzotriazole skeleton or a benzothiazole skeleton, and the content of the solder particles in 100% by weight of the conductive material is less than 85% by weight.

In a specific aspect of the conductive material according to the present invention, the compound having a benzotriazole skeleton or a benzothiazole skeleton has a thiol group.

In a specific aspect of the conductive material according to the present invention, the compound having a benzotriazole skeleton or a benzothiazole skeleton is a primary thiol.

In a specific aspect of the conductive material according to the present invention, the compound having a benzotriazole skeleton or a benzothiazole skeleton is attached on the surface of the solder particle.

In a specific aspect of the conductive material according to the present invention, the content of the compound having a benzotriazole skeleton or a benzothiazole skeleton in 100% by weight of the conductive material is 0.01% by weight or more and 5% by weight or less.

In a specific aspect of the conductive material according to the present invention, the solder particle includes a solder particle body and a covering portion disposed on the surface of the solder particle body.

In a specific aspect of the conductive material according to the present invention, the covering portion contains an organic compound, an inorganic compound, an organic-inorganic hybrid compound, or a metal.

In a specific aspect of the conductive material according to the present invention, the solder particle body contains tin and bismuth.

In a specific aspect of the conductive material according to the present invention, the covering portion contains silver, and the content of the silver in 100% by weight of the solder particles is 1% by weight or more and 20% by weight or less.

In a specific aspect of the conductive material according to the present invention, a surface area of the surface of the solder particle body covered with the covering portion is 80% or more relative to the entire 100% of the surface area of the solder particle body.

In a specific aspect of the conductive material according to the present invention, the covering portion has a thickness of 0.1 μm or more and 5 μm or less.

In a specific aspect of the conductive material according to the present invention, the solder particles include a nickel-containing metal portion between an outer surface of the solder particle body and the covering portion.

In a specific aspect of the conductive material according to the present invention, the content of the solder particles in 100% by weight of the conductive material is more than 50% by weight.

In a specific aspect of the conductive material according to the present invention, the thermosetting compound includes a thermosetting compound having a polyether skeleton.

In a specific aspect of the conductive material according to the present invention, the conductive material contains a flux having a melting point of 50° C. or more and 140° C. or less.

In a specific aspect of the conductive material according to the present invention, the solder particle has on its outer surface a carboxyl group or an amino group.

In a specific aspect of the conductive material according to the present invention, the conductive material has a viscosity at 25° C. of 20 Pa·s or more and 600 Pa·s or less.

In a specific aspect of the conductive material according to the present invention, the conductive material is a conductive paste.

According to a broad aspect of the present invention, there is provided a connection structure including a first connection object member having at least one first electrode on its surface, a second connection object member having at least one second electrode on its surface, and a connection portion connecting the first connection object member and the second connection object member. In this connection structure, the connection portion is formed of the above-described conductive material, and the first electrode and the second electrode are electrically connected by a solder portion in the connection portion.

In a specific aspect of the connection structure according to the present invention, when viewing a portion where the first electrode and the second electrode face each other in a stacking direction of the first electrode, the connection portion, and the second electrode, the solder portion in the connection portion is placed in 50% or more of 100% of the area of the portion where the first electrode and the second electrode face each other.

### Effect of the Invention

The conductive material according to the present invention contains a thermosetting compound and a plurality of solder particles. In the conductive material according to the present invention, the concentration of free tin ions in the conductive material is 100 ppm or less. In the conductive material according to the present invention, since the above configuration is provided, even when the conductive material is left for a certain period of time, the solder can be efficiently placed on the electrode, and, in addition, the wettability of the solder can be improved.

### BRIEF DESCRIPTION OF DRAWINGS

FIG. 1 is a cross-sectional view schematically showing a connection structure obtained using a conductive material according to one embodiment of the present invention.

FIGS. 2(a) to 2(c) are cross-sectional views for explaining respective processes of an example of a method for producing a connection structure using the conductive material according to one embodiment of the present invention.

FIG. 3 is a cross-sectional view showing a modified example of the connection structure.

FIG. 4 is a cross-sectional view showing a solder particle usable for a conductive material according to a first embodiment of the present invention.

FIG. 5 is a cross-sectional view showing a solder particle usable for a conductive material according to a second embodiment of the present invention.

FIG. 6 is a cross-sectional view showing a solder particle usable for a conductive material according to a third embodiment of the present invention.

### MODES FOR CARRYING OUT THE INVENTION

Hereinafter, the details of the present invention will be described.

(Conductive Material)

The conductive material according to the present invention contains a thermosetting compound and a plurality of solder particles. In the conductive material according to the present invention, the concentration of free tin ions in the conductive material is 100 ppm or less.

In the present invention, since the above configuration is provided, even when the conductive material is left for a certain period of time, solder can be efficiently placed on an electrode, and, in addition, wettability of the solder can be improved.

At the time of producing the connection structure, after the conductive material is placed on a connection object member such as a substrate by screen printing or the like, the conductive material may be left for a certain period of time before the conductive material is electrically connected. In conventional conductive materials, for example, when the conductive material is left for a certain period of time after the conductive material is placed, the conductive material is thickened, and solder cannot be efficiently placed on the electrode, so that conduction reliability between the electrodes may be reduced. In the present invention, since the above configuration is adopted, even when the conductive material is left for a certain period of time after the conductive material is placed, it is possible to prevent thickening of the conductive material and to efficiently place the solder on the electrode, so that the conduction reliability between the electrodes can be sufficiently enhanced.

Further, in the present invention, in order to correspond to electrodes having a small electrode width and a small inter-electrode width, oxidation of the surface of solder particles can be prevented even if the particle diameter of the solder particles is reduced, and the wettability of the solder can be maintained good. In conventional conductive materials, when the electrode width or the inter-electrode width is small, there is a tendency that it is difficult to collect solder on the electrode. In the present invention, even if the electrode width or the inter-electrode width is narrow, it is possible to sufficiently collect the solder on the electrode.

In the present invention, in order to obtain the above-described effect, the fact that the concentration of free tin ions in the conductive material is 100 ppm or less contributes greatly.

Further, in the present invention, since the above configuration is provided, when the electrodes are electrically connected, the plurality of solder particles are likely to gather between the upper and lower opposed electrodes, and the plurality of solder particles can be efficiently placed on the electrode (line). In addition, such a phenomenon that some solder particles are placed in a region (space) where no electrode is formed is suppressed, and the amount of the solder particles placed in the region where no electrode is formed can be considerably reduced. Accordingly, the conduction reliability between the electrodes can be enhanced. In addition, it is possible to prevent electrical connection between electrodes that must not be connected and are adjacent in a lateral direction, and insulation reliability can be enhanced.

Furthermore, in the present invention, it is possible to prevent positional displacement between the electrodes. In the present invention, when a second connection object member is superimposed on a first connection object member with the conductive material disposed on its upper surface, even in a misalignment state between a first electrode and a second electrode, the misalignment can be corrected, and the first electrode and the second electrode can be connected (self-alignment effect).

In the conductive material according to the present invention, the concentration of free tin ions in the conductive material is 100 ppm or less. The concentration of free tin ions in the conductive material is preferably 80 ppm or less, more preferably 60 ppm or less, further preferably 45 ppm or less. The lower limit of the concentration of free tin ions in the conductive material is not particularly limited. The concentration of free tin ions in the conductive material may be 10 ppm or more. When the concentration of free tin ions in the conductive material is not more than the above upper limit, it is possible to more effectively prevent the thickening of the conductive material. As a result, even when the conductive material is left for a certain period of time, the solder can be more efficiently placed on the electrode, and the wettability of the solder can be further improved.

The concentration of free tin ions in the conductive material can be measured using, for example, a high-frequency inductively coupled plasma emission spectrometer (“ICP-AES” manufactured by Horiba, Ltd.).

From the viewpoint of more efficiently placing the solder on the electrode, the conductive material is preferably in a liquid state at 25° C. and is preferably a conductive paste.

The viscosity (η25) of the conductive material at 25° C. is preferably 20 Pa·s or more, more preferably 30 Pa·s or more, and preferably 600 Pa·s or less, more preferably 400 Pa·s or less, further preferably 300 Pa·s or less. When the viscosity (η25) is not less than the above lower limit and not more than the above upper limit, the solder can be more efficiently placed on the electrode even when the conductive material is left for a certain period of time, and the wettability of the solder can be further improved. The viscosity (η25) can be appropriately adjusted depending on the type of compounded components and the blending amount.

The viscosity (η25) can be measured under conditions of 25° C. and 5 rpm, for example, using an E-type viscometer (“TVE22L” manufactured by Toki Sangyo Co., Ltd.) or the like.

The viscosity (ηmp) of the conductive material at the melting point of the solder particles is preferably 0.1 Pa·s or more, more preferably 0.5 Pa·s or more, and preferably 5 Pa·s or less, more preferably 1 Pa·s or less. When the viscosity (ηmp) is not less than the above lower limit and not more than the above upper limit, the solder can be more efficiently placed on the electrode even when the conductive material is left for a certain period of time, and the wettability of the solder can be further improved. The viscosity (ηmp) can be appropriately adjusted depending on the type of compounded components and blending amount.

The melting point of the solder particles is a temperature likely to affect movement of the solder particles onto the electrode.

The viscosity (ηmp) of the conductive material at the melting point of the solder particles can be measured using, for example, STRESSTECH (manufactured by REOLOGICA) or the like under conditions of a strain control of 1 rad, a frequency of 1 Hz, a temperature rising rate of 20° C./min, and a measurement temperature range of 40° C. to the melting point of the solder particles. In this measurement, the viscosity at the melting point of the solder particles is taken as the viscosity (ηmp) of the conductive material.

The conductive material may be used as a conductive paste, a conductive film, or the like. The conductive paste is preferably an anisotropic conductive paste, and the conductive film is preferably an anisotropic conductive film. From the viewpoint of more efficiently placing the solder on the electrode, the conductive material is preferably a conductive paste. The conductive material is suitably used for electrical connection of electrodes. The conductive material is preferably a circuit connecting material.

Hereinafter, each component contained in the conductive material will be described. In the present specification, “(meth)acryl” means one or both of “acrylic” and “methacrylic”, “(meth) acrylate” means one or both of “acrylate” and “methacrylate”, and “(meth)acryloyl” means one or both of “acryloyl” and “methacryloyl”.

(Solder Particles)

It is preferable that both the center portion and the outer surface of the solder particles are formed of solder. The solder particle is preferably a particle whose both center portion and outer surface are solder. The solder particle may include a solder particle body and a covering portion disposed on the surface of the solder particle body. The solder particle body is formed of solder. The solder particle body is a particle whose both center portion and outer surface are solder. When conductive particles including base particles formed from materials other than solder and a solder portion placed on the surface of the base particles are used instead of the solder particles, the conductive particles hardly gather on the electrode. In the conductive particles, since the solder-bonding property between the conductive particles is low, the conductive particles moved on the electrode tend to move outside the electrode, and the effect of suppressing positional displacement between the electrodes tends to be low.

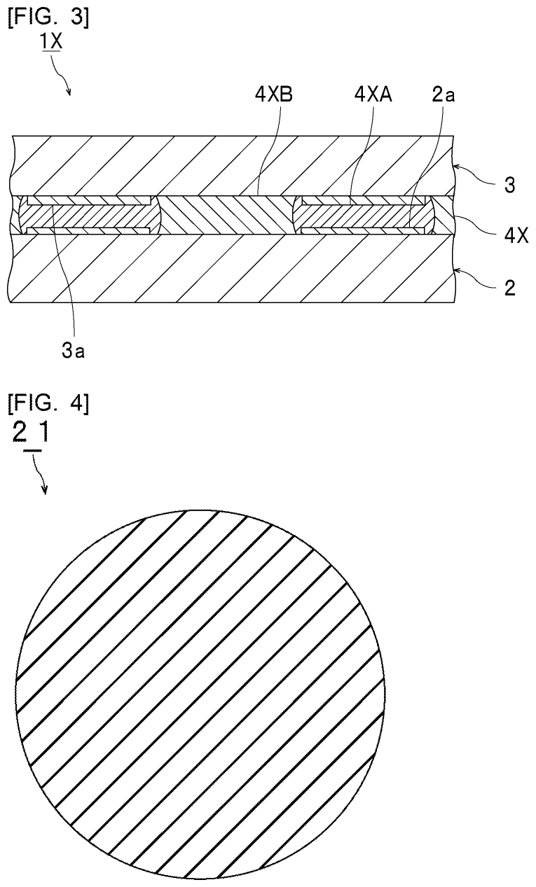

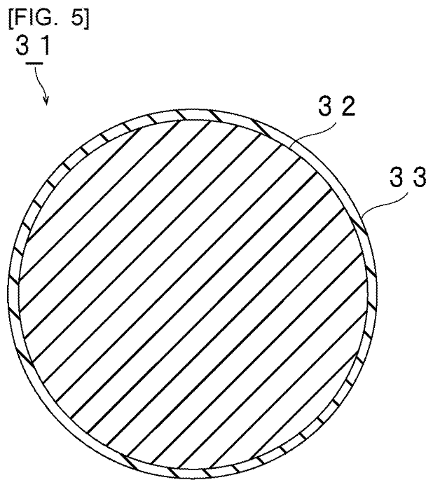

FIG. 4 is a cross-sectional view showing a solder particle usable for a conductive material according to a first embodiment of the present invention.

The entire solder particle 21 shown in FIG. 4 is formed of solder. The solder particle 21 does not have a base particle in the core and is not a core shell particle. In the solder particle 21, both the center portion and an outer surface portion of a conductive portion are formed of solder.

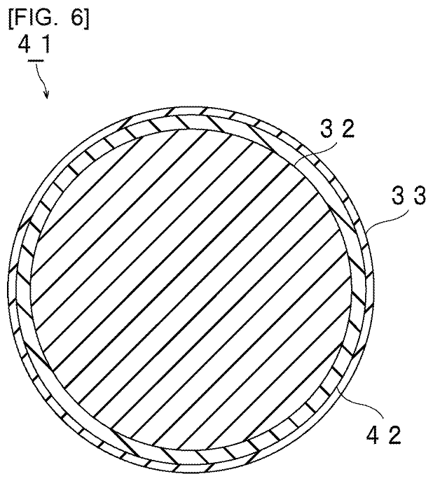

FIG. 5 is a cross-sectional view showing a solder particle usable for a conductive material according to a second embodiment of the present invention.

A solder particle 31 shown in FIG. 5 includes a solder particle body 32 and a covering portion 33 disposed on the surface of the solder particle body 32. The covering portion 33 covers the surface of the solder particle body 32. The solder particle 31 is a covered particle in which the surface of the solder particle body 32 is covered with the covering portion 33. The covering portion may or may not completely cover the surface of the solder particle body. The solder particle body may have a portion not covered with the covering portion.

FIG. 6 is a cross-sectional view showing a solder particle usable for a conductive material according to a third embodiment of the present invention.

A solder particle 41 shown in FIG. 6 includes the solder particle body 32, a metal portion 42 disposed on the surface of the solder particle body 32, and the covering portion 33 disposed on the surface of the metal portion 42. The solder particle 41 includes the metal portion 42 between the solder particle body 32 and the covering portion 33. The metal portion 42 covers the surface of the solder particle body 32. The covering portion 33 covers the surface of the metal portion 42. The metal portion 42 preferably contains nickel. The solder particle 41 is a covered particle in which the surface of the solder particle body 32 is covered with the metal portion 42 and the covering portion 33.

From the viewpoint of further lowering connection resistance in the connection structure and further suppressing generation of voids, it is preferable that the surface of the solder of the solder particles or the surface of the covering portion has a carboxyl group or an amino group, preferably the carboxyl group, and preferably the amino group. It is preferable that a group containing a carboxyl group or an amino group is covalently bonded to the surface of the solder of the solder particles or the surface of the covering portion via a Si—O bond, an ether bond, an ester bond or a group represented by the following formula (X). The group containing a carboxyl group or an amino group may contain both the carboxyl group and the amino group. In the following formula (X), the right end and the left end represent binding sites.

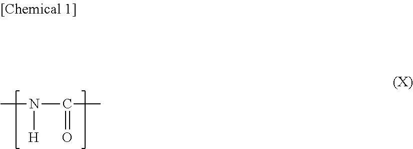

A hydroxyl group is present on the surface of the solder or the surface of the covering portion. When the hydroxyl group and a carboxyl group-containing group are covalently bonded, a stronger bond can be formed as compared with the case where the hydroxyl group and the group containing a carboxyl group are bonded by another coordinate bond (chelate coordination) or the like, so that it is possible to obtain solder particles capable of lowering the connection resistance between the electrodes and suppressing generation of voids.

In the solder particles, the bond form between the surface of the solder or the surface of the covering portion and the carboxyl group-containing group may not include a coordination bond and a bond according to chelate coordination

It is preferable that the solder particles are obtained by reacting a functional group capable of reacting with a hydroxyl group with the hydroxyl group on the surface of the solder or the surface of the covering portion, using a compound (hereinafter sometimes to be referred to as compound X) having a carboxyl group and the functional group capable of reacting with a hydroxyl group. The solder particles obtained according to the above preferable aspect can effectively lower the connection resistance in the connection structure, and generation of voids can be effectively suppressed. In the above reaction, a covalent bond is formed. The solder particles in which the carboxyl group-containing group is covalently bonded to the surface of the solder or the surface of the covering portion can be easily obtained by reacting a hydroxyl group on the surface of the solder or the surface of the covering portion with the functional group capable of reacting with a hydroxyl group in the compound X. In addition, the solder particles in which the carboxyl group-containing group is covalently bonded to the surface of the solder or the surface of the covering portion via an ether bond or an ester bond can be obtained by reacting a hydroxyl group on the surface of the solder or the surface of the covering portion with the functional group capable of reacting with a hydroxyl group in the compound X. The compound X can be chemically bonded in the form of a covalent bond to the surface of the solder or the surface of the covering portion by reacting the functional group capable of reacting with a hydroxyl group with the hydroxyl group on the surface of the solder or the surface of the covering portion.

Examples of the functional group capable of reacting with a hydroxyl group include a hydroxyl group, a carboxyl group, an ester group and a carbonyl group. A hydroxyl group or a carboxyl group is preferred. The functional group capable of reacting with a hydroxyl group may be a hydroxyl group or a carboxyl group.

Examples of a compound having a functional group capable of reacting with a hydroxyl group include levulinic acid, glutaric acid, glycolic acid, succinic acid, malic acid, oxalic acid, malonic acid, adipic acid, 5-ketohexanoic acid, 3-hydroxypropionic acid, 4-aminobutyric acid, 3-mercaptopropionic acid, 3-mercaptoisobutyric acid, 3-methylthiopropionic acid, 3-phenylpropionic acid, 3-phenylisobutyric acid, 4-phenylbutyric acid, decanoic acid, dodecanoic acid, tetradecanoic acid, pentadecanoic acid, hexadecanoic acid, 9-hexadecenoic acid, heptadecanoic acid, stearic acid, oleic acid, vaccenic acid, linoleic acid, (9,12,15)-linolenic acid, nonadecanoic acid, arachidic acid, decanedioic acid and dodecanedioic acid. Glutaric acid or glycolic acid is preferred. One kind of the compound having the functional group capable of reacting with a hydroxyl group may be used alone, and two or more kinds thereof may be used in combination. The compound having the functional group capable of reacting with a hydroxyl group is preferably a compound having at least one carboxyl group.

The compound X preferably has a flux action, and it is preferable that the compound X has the flux action in a state of being bonded to the surface of the solder or the surface of the covering portion. The compound having the flux action can remove an oxide film on the surface of the solder or the surface of the covering portion and an oxide film on the surface of the electrode. A carboxyl group has the flux action.

Examples of the compound having the flux action include levulinic acid, glutaric acid, glycolic acid, succinic acid, 5-ketohexanoic acid, 3-hydroxypropionic acid, 4-aminobutyric acid, 3-mercaptopropionic acid, 3-mercaptoisobutyric acid, 3-methylthiopropionic acid, 3-phenylpropionic acid, 3-phenylisobutyric acid and 4-phenylbutyric acid. Glutaric acid or glycolic acid is preferred. One kind of the compound having the flux action may used alone, and two or more kinds thereof may be used in combination.

From the viewpoint of effectively lowering the connection resistance in the connection structure and effectively suppressing generation of voids, it is preferable that the functional group capable of reacting with a hydroxyl group in the compound X is a hydroxyl group or a carboxyl group. The functional group capable of reacting with a hydroxyl group in the compound X may be a hydroxyl group or a carboxyl group. When the functional group capable of reacting with a hydroxyl group is a carboxyl group, it is preferable that the compound X has at least two carboxyl groups. The solder particles in which the carboxyl group-containing group is covalently bonded to the surface of the solder or the surface of the covering portion can be obtained by reacting a carboxyl group of a portion of a compound having at least two carboxyl groups with a hydroxyl group on the surface of the solder or the surface of the covering portion.

A method of producing the solder particles includes, for example, a process of mixing solder particles, a compound having a functional group capable of reacting with a hydroxyl group and a carboxyl group, a catalyst, and a solvent with the use of the solder particles. In the method of producing solder particles, solder particles in which the carboxyl group-containing group is covalently bonded to the surface of the solder or the surface of the covering portion can be easily obtained by the mixing process.

Further, in the method of producing solder particles, it is preferable that solder particles, the compound having the functional group capable of reacting with a hydroxyl group and a carboxyl group, the catalyst, and the solvent are mixed using the solder particles and heated. The solder particles in which the carboxyl group-containing group is covalently bonded to the surface of the solder or the surface of the covering portion can be more easily obtained by the mixing and heating process.

Examples of the solvent include alcohol solvents such as methanol, ethanol, propanol and butanol, acetone, methyl ethyl ketone, ethyl acetate, toluene and xylene. The solvent is preferably an organic solvent, more preferably toluene. One kind of the solvent may be used alone, and two or more kinds thereof may be used in combination.

Examples of the catalyst include p-toluenesulfonic acid, benzenesulfonic acid and 10-camphorsulfonic acid. The catalyst is preferably p-toluenesulfonic acid. One kind of the catalyst may be used alone, and two or more kinds thereof may be used in combination.

It is preferable to heat at the time of the mixing. The heating temperature is preferably 90° C. or more, more preferably 100° C. or more, and preferably 130° C. or less, more preferably 110° C. or less.

From the viewpoint of effectively lowering the connection resistance in the connection structure and effectively suppressing generation of voids, it is preferable that the solder particles are obtained using an isocyanate compound through a process of reacting the isocyanate compound with a hydroxyl group on the surface of the solder or the surface of the covering portion. In the above reaction, a covalent bond is formed. The solder particles in which a nitrogen atom of a group derived from the isocyanate group is covalently bonded to the surface of the solder or the surface of the covering portion can be easily obtained by reacting a hydroxyl group on the surface of the solder or the surface of the covering portion with the isocyanate compound. The group derived from the isocyanate group can be chemically bonded in the form of a covalent bond to the surface of the solder or the surface of the covering portion by reacting the isocyanate compound with the hydroxyl group on the surface of the solder or the surface of the covering portion.

Examples of the isocyanate compound include diphenylmethane-4,4′-diisocyanate (MDI), hexamethylene diisocyanate (HDI), toluene diisocyanate (TDI) and isophorone diisocyanate (IPDI). Other isocyanate compounds may be used. After the isocyanate compound is reacted with the surface of the solder or the surface of the covering portion, the remaining isocyanate group and a compound having reactivity with the remaining isocyanate group and having a carboxyl group are reacted, whereby the carboxyl group can be introduced onto the surface of the solder or the surface of the covering portion via the group represented by the above formula (X).

As the isocyanate compound, a compound having an unsaturated double bond and having an isocyanate group may be used. Examples thereof include 2-acryloyloxyethyl isocyanate and 2-isocyanatoethyl methacrylate. After the isocyanate group of the compound is reacted with the surface of the solder or the surface of the covering portion, a compound which has a functional group having reactivity with the remaining unsaturated double bond and has a carboxyl group is reacted, so that the carboxyl group can be introduced onto the surface of the solder or the surface of the covering portion via the group represented by the above formula (X).

As the isocyanate compound, an isocyanate group-containing silane coupling agent may be used. After the isocyanate group of the silane coupling agent is reacted with the surface of the solder or the surface of the covering portion, a compound having reactivity with the remaining group and having a carboxyl group is reacted, so that the carboxyl group can be introduced onto the surface of the solder or the surface of the covering portion via the group represented by the above formula (X).

Examples of the isocyanate group-containing silane coupling agent include 3-isocyanatepropyltriethoxysilane (“KBE-9007” manufactured by Shin-Etsu Chemical Co., Ltd.) and 3-isocyanatepropyltrimethoxysilane (“Y-5187” manufactured by Momentive Performance Materials Inc). One kind of the silane coupling agent may be used alone, and two or more kinds thereof may be used in combination.

The isocyanate group can easily react with the silane coupling agent. It is preferable that the carboxyl group is introduced by a reaction using a carboxyl group-containing silane coupling agent, or it is preferable that after a reaction using the isocyanate group-containing silane coupling agent, the carboxyl group is introduced by reacting a compound having at least one carboxyl group with the group derived from the silane coupling agent. By satisfying the above preferable aspect, the solder particles can be easily obtained.

It is preferable that the solder particles are obtained by reacting the isocyanate compound with the hydroxyl group on the surface of the solder or the surface of the covering portion with the use of the isocyanate compound and then reacting the compound having at least one carboxyl group.

From the viewpoint of further lowering connection resistance in the connection structure and further suppressing generation of voids, it is preferable that the compound having at least one carboxyl group has a plurality of carboxyl groups.

Examples of the compound having at least one carboxyl group include levulinic acid, glutaric acid, glycolic acid, succinic acid, malic acid, oxalic acid, malonic acid, adipic acid, 5-ketohexanoic acid, 3-hydroxypropionic acid, 4-aminobutyric acid, 3-mercaptopropionic acid, 3-mercaptoisobutyric acid, 3-methylthiopropionic acid, 3-phenylpropionic acid, 3-phenylisobutyric acid, 4-phenylbutyric acid, decanoic acid, dodecanoic acid, tetradecanoic acid, pentadecanoic acid, hexadecanoic acid, 9-hexadecenoic acid, heptadecanoic acid, stearic acid, oleic acid, vaccenic acid, linoleic acid, (9,12,15)-linolenic acid, nonadecanoic acid, arachidic acid, decanedioic acid and dodecanedioic acid. Glutaric acid, adipic acid or glycolic acid is preferred. One kind of the compound having at least one carboxyl group may be used alone, and two or more kinds thereof may be used in combination.

After the isocyanate compound is reacted with the hydroxyl group on the surface of the solder or the surface of the covering portion with the use of the isocyanate compound, a carboxyl group of a portion of a compound having a plurality of carboxyl groups is reacted with the hydroxyl group on the surface of the solder or the surface of the covering portion, so that the carboxyl group-containing group can be allowed to remain.

In the method of producing solder particles, an isocyanate compound is reacted with the hydroxyl group on the surface of the solder or the surface of the covering portion by using solder particles and the isocyanate compound. Thereafter, a compound having at least one carboxyl group is reacted to obtain solder particles in which the carboxyl group-containing group is bonded to the surface of the solder or the surface of the covering portion via the group represented by the above formula (X). In the method of producing solder particles, solder particles in which the carboxyl group-containing group is introduced onto the surface of the solder or the surface of the covering portion can be easily obtained by the above process.

Specific method of producing solder particles include the following methods. Solder particles are dispersed in an organic solvent, and an isocyanate group-containing silane coupling agent is added. Thereafter, a silane coupling agent is covalently bonded to the surface of the solder or the surface of the covering portion by using a reaction catalyst for the hydroxyl group on the surface of the solder of the solder particles or the surface of the covering portion and the isocyanate group. Then, a hydroxyl group is generated by hydrolyzing an alkoxy group bonded to a silicon atom of the silane coupling agent. A carboxyl group of the compound having at least one carboxyl group is reacted with the generated hydroxyl group.

Specific methods of producing solder particles include the following methods. Solder particles are dispersed in an organic solvent, and a compound having an isocyanate group and an unsaturated double bond is added. Thereafter, a covalent bond is formed using a reaction catalyst for the hydroxyl group on the surface of the solder of the solder particles or the surface of the covering portion and the isocyanate group. Thereafter, a compound having an unsaturated double bond and a carboxyl group is reacted with the introduced unsaturated double bond.

Examples of the reaction catalyst for the hydroxyl group on the surface of the solder of the solder particles or the surface of the covering portion and the isocyanate group include a tin catalyst (such as dibutyltin dilaurate), an amine catalyst (such as triethylenediamine), a carboxylate catalyst (such as lead naphthenate and potassium acetate), and a trialkylphosphine catalyst (such as triethylphosphine).

From the viewpoint of effectively lowering the connection resistance in the connection structure and effectively suppressing generation of voids, the compound having at least one carboxyl group is preferably a compound represented by the following formula (1). The compound represented by the following formula (1) has the flux action. The compound represented by the following formula (1) has the flux action in a state of being introduced onto the surface of the solder or the surface of the covering portion.

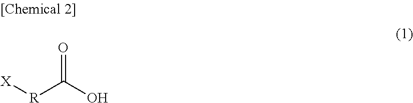

In the above formula (1), X represents a functional group capable of reacting with a hydroxyl group, and R represents a divalent organic group having 1 to 5 carbon atoms. The organic group may contain a carbon atom, a hydrogen atom, and an oxygen atom. The organic group may be a divalent hydrocarbon group having 1 to 5 carbon atoms. The main chain of the organic group is preferably a divalent hydrocarbon group. In the organic group, a carboxyl group or a hydroxyl group may be bonded to the divalent hydrocarbon group. The compound represented by the above formula (1) include, for example, citric acid.

The compound having at least one carboxyl group is preferably a compound represented by the following formula (1A) or (1B). The compound having at least one carboxyl group is preferably the compound represented by the following formula (1A), more preferably the compound represented by the following formula (1B).

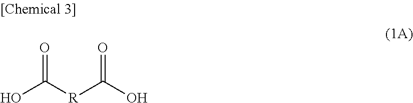

In the above formula (1A), R represents a divalent organic group having 1 to 5 carbon atoms. R in the above formula (1A) is the same as R in the above formula (1).

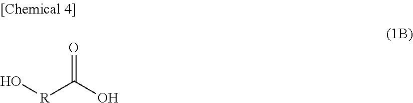

In the above formula (1B), R represents a divalent organic group having 1 to 5 carbon atoms. R in the above formula (1B) is the same as R in the above formula (1).

It is preferable that a group represented by the following formula (2A) or the following formula (2B) is bonded to the surface of the solder or the surface of the covering portion. It is preferable that the group represented by the following formula (2A) is bonded to the surface of the solder or the surface of the covering portion, and it is more preferable that the group represented by the following formula (2B) is bonded to the surface of the solder or the surface of the covering portion. In the following formulas (2A) and (2B), the left end represents a binding site.

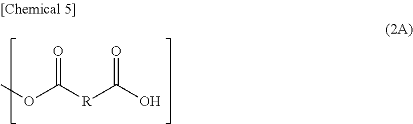

In the above formula (2A), R represents a divalent organic group having 1 to 5 carbon atoms. R in the above formula (2A) is the same as R in the above formula (1).

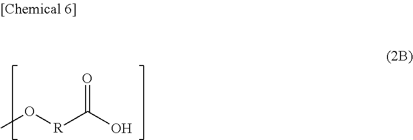

In the above formula (2B), R represents a divalent organic group having 1 to 5 carbon atoms. R in the above formula (2B) is the same as R in the above formula (1).

From the viewpoint of further enhancing wettability of the surface of the solder or the surface of the covering portion, the molecular weight of the compound having at least one carboxyl group is preferably 10,000 or less, more preferably 1000 or less, further preferably 500 or less.

When the compound having at least one carboxyl group is not a polymer and when a structural formula of the compound having at least one carboxyl group can be specified, the molecular weight means a molecular weight that can be calculated from the structural formula. When the compound having at least one carboxyl group is a polymer, this molecular weight means a weight average molecular weight.

From the viewpoint of more efficiently placing the solder on the electrode, it is preferable that the solder particle has a solder particle body and an anionic polymer disposed on the surface of the solder particle body. It is preferable that the solder particles are obtained by surface-treating the solder particle body with an anionic polymer or a compound to be an anionic polymer. The solder particle is preferably a surface-treated product obtained using an anionic polymer or a compound to be an anionic polymer. One kind of the anionic polymer or the compound to be an anionic polymer may be used alone, and two or more kinds thereof may be used in combination. The anionic polymer is a polymer having an acidic group.

Examples of the method of surface-treating the solder particle body with an anionic polymer include a method of reacting a carboxyl group of the following anionic polymer with a hydroxyl group on the surface of the solder particle body. Examples of the anionic polymer include a (meth)acrylic polymer obtained by copolymerizing (meth)acrylic acid, a polyester polymer synthesized from dicarboxylic acid and diol and having carboxyl groups at both ends, a polymer obtained by an intermolecular dehydration condensation reaction of dicarboxylic acid and having carboxyl groups at both ends, a polyester polymer synthesized from dicarboxylic acid and diamine and having carboxyl groups at both ends, and modified poval (“GOHSENX T” manufactured by The Nippon Synthetic Chemical Industry Co., Ltd.) having a carboxyl group.

Examples of the anion moiety of the anionic polymer include the carboxyl group, and besides a tosyl group (p-H₃CC₆H₄S(═O)₂—), a sulfonic acid ion group (—SO₃—), and a phosphate ion group (—PO₄—).

Examples of other methods of surface-treating the solder particle body with an anionic polymer include a method in which a compound, which has a functional group reacting with a hydroxyl group on the surface of the solder particle body and has a functional group polymerizable by an addition and condensation reaction, is used, and this compound is polymerized on the surface of the solder particle body. Examples of the functional group reacting with the hydroxyl group on the surface of the solder particle body include a carboxyl group and an isocyanate group, and examples of the functional group polymerized by the addition and condensation reaction include a hydroxyl group, a carboxyl group, an amino group, and a (meth)acryloyl group.

The weight average molecular weight of the anionic polymer is preferably 2000 or more, more preferably 3000 or more, and preferably 10000 or less, more preferably 8000 or less. When the weight average molecular weight is not less than the above lower limit and not more than the above upper limit, a sufficient amount of electric charge and flux properties can be introduced to the surface of the solder particles. This makes it possible to effectively remove an oxide film on the surface of the electrode when a connection object member is connected.

When the weight average molecular weight is not less than the above lower limit and not more than the above upper limit, it is easy to dispose an anionic polymer on the surface of the solder particle body, and the solder can be more efficiently placed on the electrode.

The weight average molecular weight means a weight average molecular weight in terms of polystyrene measured by gel permeation chromatography (GPC).

The weight average molecular weight of a polymer obtained by surface-treating the solder particle body with the compound to be an anionic polymer can be determined by dissolving the solder in the solder particles, removing the solder particles with diluted hydrochloric acid or the like which does not cause decomposition of the polymer, and then measuring the weight average molecular weight of the remaining polymer.

With respect to the amount of anionic polymer introduced to the surface of the solder particles, the acid value per 1 g of the solder particles is preferably 1 mg KOH or more, more preferably 2 mg KOH or more, and preferably 10 mg KOH or less, more preferably 6 mg KOH or less.

The acid value can be measured as follows. 1 g of solder particles is added to 36 g of acetone and dispersed by ultrasonic wave for 1 minute. Thereafter, phenolphthalein is used as an indicator, and titration is performed with a 0.1 mol/L potassium hydroxide ethanol solution.

The solder is preferably a metal (low melting point metal) having a melting point of 450° C. or less. The solder particles and the solder particle body are preferably metal particles (low melting point metal particles) having a melting point of 450° C. or less. The low melting point metal particle is a particle containing a low melting point metal. The low melting point metal indicates a metal having a melting point of 450° C. or less. The melting point of the low melting point metal is preferably 300° C. or less, more preferably less than 200° C., further preferably 160° C. or less. The solder particles and the solder particle body are preferably low melting point solder having a melting point of less than 150° C.

It is preferable that the solder particles and the solder particle body contain tin and bismuth. The content of tin in 100% by weight of metal contained in the solder particles and the solder particle body is preferably 30% by weight or more, more preferably 40% by weight or more, further preferably 70% by weight or more, particularly preferably 90% by weight or more. When the content of tin in the solder particles and the solder particle body is not less than the above lower limit, connection reliability between a solder portion and the electrode is further enhanced. The content of bismuth in 100% by weight of metal contained in the solder particles and the solder particle body is preferably 40% by weight or more, more preferably 45% by weight or more, further preferably 48% by weight or more, particularly preferably 50% by weight or more. When the content of bismuth in the solder particles and the solder particle body is not less than the above lower limit, connection reliability between a solder portion and the electrode is further enhanced.

Here, the content of tin or bismuth can be measured by using a high-frequency inductively coupled plasma emission spectrometry apparatus (“ICP-AES” manufactured by Horiba, Ltd.), a fluorescence X-ray analyzing apparatus (“EDX-800HS” manufactured by Shimadzu Corporation), or the like.

By using the solder particles or the solder particle body, the solder melts and is bonded to the electrode, and the solder portion conducts between the electrodes. For example, since the solder and the electrode are easily in surface contact, not in point contact, the connection resistance decreases. Further, the use of the solder particles or the solder particle body increases bonding strength between the solder portion and the electrode, so that peeling between the solder portion and the electrode more hardly occurs, and conduction reliability and connection reliability further increase.

The low melting point metal constituting the solder particles and the solder particle body is not particularly limited. The melting point of the low melting point metal is preferably less than 200° C. The low melting point metal is preferably tin or an alloy containing tin. Examples of the alloy include tin-silver alloy, tin-copper alloy, tin-silver-copper alloy, tin-bismuth alloy, tin-zinc alloy, and tin-indium alloy. Among these, the low melting point metal is preferably tin, tin-silver alloy, tin-silver-copper alloy, tin-bismuth alloy, or tin-indium alloy because of being excellent in wettability to the electrodes. The low melting point metal is more preferably tin-bismuth alloy or tin-indium alloy.

The solder particles and the solder particle body are each preferably a filler material having a liquidus line of 450° C. or less in accordance with JIS 23001: Welding Terms. Examples of the compositions of the solder particles and the solder particle body include metallic compositions including zinc, gold, silver, lead, copper, tin, bismuth and indium. Particularly, a low-melting and lead-free tin-indium-based (eutectic 117° C.) or tin-bismuth-based (eutectic 139° C.) solder is preferable. In other words, it is preferred that the solder particles and the solder particle body do not contain lead and are those containing tin and indium or containing tin and bismuth.

In order to further increase the bonding strength of the solder portion to the electrodes, the solder particles and the solder particle body may contain a metal such as nickel, copper, antimony, aluminum, zinc, iron, gold, titanium, phosphorus, germanium, tellurium, cobalt, bismuth, manganese, chromium, molybdenum, or palladium. From the viewpoint of further increasing the bonding strength of the solder portion to the electrodes, the solder particles and the solder particle body preferably contain nickel, copper, antimony, aluminum, or zinc. From the viewpoint of furthermore increasing the bonding strength of the solder portion to the electrodes, the content of these metals for increasing the bonding strength is preferably 0.0001% by weight or more and preferably 1% by weight or less in 100% by weight of the solder particles and the solder particle body.

The solder particles and the solder particle body each have a particle diameter of preferably 0.5 μm or more, more preferably 1 μm or more, further preferably 3 μm or more, particularly preferably 5 μm or more. The solder particles and the solder particle body each have a particle diameter of preferably 100 μm or less, more preferably 40 μm or less, still more preferably 30 μm or less, further preferably 20 μm or less, particularly preferably 15 μm or less, most preferably 10 μm or less. When the particle diameter of the solder particles and the solder particle body are not less than the above lower limit and not more than the above upper limit, the solder can be more efficiently placed on the electrode. The solder particles and the solder particle body each have a particle diameter of particularly preferably 5 μm or more and 30 μm or less.

The particle diameters of the solder particles and the solder particle body each indicate a number average particle diameter. The particle diameters of the solder particles and the solder particle body are determined by, for example, observing 50 of arbitrary solder particles or solder particle bodies with an electron microscope or an optical microscope, and calculating an average value of the particle diameter of each of the solder particles or the solder particle body or performing laser diffraction type particle size distribution measurement.

The variation coefficient (CV value) of the particle diameter of the solder particles or the solder particle body is preferably 5% or more, more preferably 10% or more, and preferably 40% or less, more preferably 30% or less. The variation coefficient of the particle diameter of the solder particles or the solder particle body is not less than the above lower limit and not more than the above upper limit, the solder can be more efficiently placed on the electrode. However, the CV values of the particle diameters of the solder particles and the solder particle body may be less than 5%.

The variation coefficient (CV value) can measured as follows.

CV value(%)=(ρ/Dn)×100

ρ: standard deviation of particle diameter of solder particles or solder particle body

Dn: average value of particle diameter of solder particles or solder particle body

The shape of the solder particles is not particularly limited. The shape of the solder particles may be spherical, and may have a shape other than a spherical shape, such as a flat shape.

(Covering Portion)

The solder particle may include a solder particle body and a covering portion disposed on the surface of the solder particle body. The covering portion is disposed on the surface of the solder particles. The covering portion preferably contains an organic compound, an inorganic compound, an organic-inorganic hybrid compound, or a metal.

The organic compound is not particularly limited. Examples of the organic compound include organic polymers. From the viewpoint of more efficiently placing the solder on the electrode and further improving the wettability of the solder even when the conductive material is left for a certain period of time, the organic compound is preferably an organic polymer, particularly preferably the anionic polymer described above.

The inorganic compound is not particularly limited. Examples of the inorganic compound include metal oxides such as silica, titania, and alumina. From the viewpoint of more efficiently placing the solder on the electrode and further improving the wettability of the solder even when the conductive material is left for a certain period of time, the inorganic compound is preferably silica.

The organic-inorganic hybrid compound is not particularly limited. Examples of the organic-inorganic hybrid compound include a silicone resin. From the viewpoint of more efficiently placing the solder on the electrode and further improving the wettability of the solder even when the conductive material is left for a certain period of time, the organic-inorganic hybrid compound is preferably silicone resin.

The metal is not particularly limited. Examples of the metal include silver, palladium, gold and nickel. From the viewpoint of more easily mounting at a low temperature and more effectively enhancing impact resistance of a connection portion, the metal is preferably silver.

From the viewpoint of more easily mounting at a low temperature and more effectively enhancing impact resistance of a connection portion, the covering portion preferably contains silver. The content of silver in 100% by weight of the solder particles is preferably 1% by weight or more, more preferably 5% by weight or more, further preferably 10% by weight or more, particularly preferably 11% by weight or more, and preferably 20% by weight or less, more preferably 15% by weight or less, further preferably 13% by weight or less. When the content of the silver is not less than the above lower limit and not more than the above upper limit, mounting at a low temperature can be more easily performed, and the impact resistance of the connection portion can be more effectively enhanced. When the content of the silver is not less than the above lower limit and not more than the above upper limit, the solder can be more efficiently placed on the electrode, and the wettability of the solder can be further improved.

The content of silver can be measured by using a high-frequency inductively coupled plasma emission spectrometry apparatus (“ICP-AES” manufactured by Horiba, Ltd.), a fluorescence X-ray analyzing apparatus (“EDX-800HS” manufactured by Shimadzu Corporation), or the like.

A surface area (coverage) of the surface of the solder particle body covered with the covering portion is preferably 80% or more, more preferably 90% or more, relative to the entire 100% of the surface area of the solder particle body. The upper limit of the coverage is not particularly limited. The coverage may be 100% or less. When the coverage is not less than the above lower limit and not more than the above upper limit, mounting at a low temperature can be more easily performed, and the impact resistance of the connection portion can be more effectively enhanced. When the coverage is not less than the above lower limit and not more than the above upper limit, the solder can be more efficiently placed on the electrode, and the wettability of the solder can be further improved.

The coverage can be calculated by performing SEM-EDX analysis on the conductive particles to perform Ag mapping and performing image analysis.

The thickness of the covering portion is preferably 0.1 μm or more, more preferably 1 μm or more, and preferably 5 μm or less, more preferably 2 μm or less. The thickness of the covering portion means the thickness of the covering portion only at a portion with the covering portion disposed on the surface of the solder particle body. A portion without the covering portion disposed on the surface of the solder particle body is not taken into consideration when the thickness of the covering portion is calculated. When the thickness of the covering portion is not less than the above lower limit and not more than the above upper limit, mounting at a low temperature can be more easily performed, and the impact resistance of the connection portion can be more effectively enhanced. When the thickness of the covering portion is not less than the above lower limit and not more than the above upper limit, the solder can be more efficiently placed on the electrode, and the wettability of the solder can be further improved.

When the covering portion is formed of only silver, the thickness of the covering portion is preferably 0.1 μm or more, more preferably 0.5 μm or more, further preferably 1 μm or more, particularly preferably 1.5 μm or more, and preferably 5 μm or less, more preferably 2 μm or less. When the thickness of the covering portion is not less than the above lower limit and not more than the above upper limit, mounting at a low temperature can be more easily performed, and the impact resistance of the connection portion can be more effectively enhanced. When the thickness of the covering portion is not less than the above lower limit and not more than the above upper limit, the solder can be more efficiently placed on the electrode, and the wettability of the solder can be further improved.

The covering portion may be a single layer or two- or more-layered (multi-layered) construction. When the covering portion is two- or more-layered (multi-layered) construction, the thickness of the covering portion means the entire thickness of the covering portion.

The thickness of the covering portion can be calculated from a difference between the particle diameter of the solder particles and the particle diameter of the solder particle body.

A ratio of the thickness of the covering portion to the particle diameter of the solder particle body (thickness of covering portion/particle diameter of solder particle body) is preferably 0.001 or more, more preferably 0.01 or more, and preferably 5 or less, more preferably 1 or less. When the ratio (thickness of covering portion/particle diameter of solder particle body) is not less than the above lower limit and not more than the above upper limit, mounting at a low temperature can be more easily performed, and the impact resistance of the connection portion can be more effectively enhanced. When the above ratio (thickness of covering portion/particle diameter of solder particle body) is not less than the above lower limit and not more than the above upper limit, the solder can be more efficiently placed on the electrode, and the wettability of the solder can be further improved.

By using the solder particles including the covering portion for the conductive material or the like, elution of metal ions from the solder particles can be effectively prevented, and thickening of the conductive material can be effectively prevented. In addition, since the solder particles include the covering portion, it is possible to effectively prevent oxidation of the surface of the solder of the solder particles, and maintain the wettability of the solder even better.

Further, when the covering portion is formed of only silver, it is preferable that before conductive connection (mounting), the solder in the solder particle body and the silver contained in the covering portion are each independently present, and are not alloyed. In this case, the solder particles before the conductive connection can be melted at the melting point of the solder particles (solder). Since the solder particles are preferably low melting point solder having a melting point of less than 200° C., the solder particles before the conductive connection (mounting) can be melted at comparatively low temperature and can easily be conductively connected (mounted) at low temperature. It is preferable that after the conductive connection (mounting), the solder of the solder particle body and silver contained in the covering portion are alloyed by heat applied at the time of the conductive connection (mounting). In this case, since the melting point of the connection portion (solder portion) after the conductive connection (mounting) is higher than the melting point of the solder particles (solder), the impact resistance of the connection portion (solder portion) can be effectively enhanced.

(Metal Portion)

It is preferable that the solder particles include a nickel-containing metal portion between an outer surface of the solder particle body and the covering portion. The solder particle preferably includes a metal portion disposed on the surface of the solder particle body and a covering portion disposed on the surface of the metal portion. When the solder particles satisfy the above preferable aspect, mounting at a low temperature can be more easily performed, and the impact resistance of the connection portion can be more effectively enhanced. When the solder particles satisfy the above preferable aspect, the solder can be more efficiently placed on the electrode, and the wettability of the solder can be further improved.

The metal portion preferably contains nickel. The metal portion may contain a metal other than nickel. The metal other than nickel contained in the metal portion is not particularly limited, and examples thereof include Gold, silver, copper, palladium, and titanium.

The thickness of the metal portion is preferably 0.1 μm or more, more preferably 1 μm or more, and preferably 5 μm or less, more preferably 2 μm or less. The thickness of the metal portion means the thickness of the metal portion only at a portion with the metal portion disposed on the surface of the solder particle body. A portion without the metal portion disposed on the surface of the solder particle body is not taken into consideration when the thickness of the metal portion is calculated. When the thickness of the metal portion is not less than the above lower limit and not more than the above upper limit, mounting at a low temperature can be more easily performed, and the impact resistance of the connection portion can be more effectively enhanced. When the thickness of the metal portion is not less than the above lower limit and not more than the above upper limit, the solder can be more efficiently placed on the electrode, and the wettability of the solder can be further improved.

When the metal portion is formed of only nickel, the thickness of the metal portion is preferably 0.1 μm or more, more preferably 0.5 μm or more, further preferably 1 μm or more, and preferably 5 μm or less, more preferably 2 μm or less. When the thickness of the metal portion is not less than the above lower limit and not more than the above upper limit, mounting at a low temperature can be more easily performed, and the impact resistance of the connection portion can be more effectively enhanced. When the thickness of the metal portion is not less than the above lower limit and not more than the above upper limit, the solder can be more efficiently placed on the electrode, and the wettability of the solder can be further improved.

The metal portion may be a single layer or two- or more-layered (multi-layered) construction. When the metal portion is two- or more-layered (multi-layered) construction, the thickness of the metal portion means the entire thickness of the metal portion.

The thickness of the metal portion can be obtained, for example, by observing the cross section of the solder particle using a transmission electron microscope (TEM).

A ratio of the thickness of the metal portion to the particle diameter of the solder particle body (thickness of metal portion/particle diameter of solder particle body) is preferably 0.001 or more, more preferably 0.01 or more, and preferably 5 or less, more preferably 1 or less. When the ratio (thickness of metal portion/particle diameter of solder particle body) is not less than the above lower limit and not more than the above upper limit, mounting at a low temperature can be more easily performed, and the impact resistance of the connection portion can be more effectively enhanced. When the above ratio (thickness of metal portion/particle diameter of solder particle body) is not less than the above lower limit and not more than the above upper limit, the solder can be more efficiently placed on the electrode, and the wettability of the solder can be further improved.

The content of the solder particles in 100% by weight of the conductive material is preferably more than 50% by weight, and preferably less than 85% by weight. The content of the solder particles in 100% by weight of conductive material is preferably more than 50% by weight, more preferably 55% by weight or more, further preferably 60% by weight or more, particularly preferably 65% by weight or more, and preferably less than 85% by weight, more preferably 80% by weight or less, further preferably 75% by weight or less, particularly preferably 70% by weight or less. When the content of the solder particles is not less than the above lower limit and not more than the above upper limit, the solder can be more efficiently placed on the electrode, it is easy to place more solder particles between the electrodes, and the conduction reliability further increases. From the viewpoint of further increasing the conduction reliability, it is more preferable as the content of the solder particles is larger. In the conductive material, the content of the solder particles in 100% by weight of the conductive material may be 50% by weight or less, 40% by weight or less, or 20% by weight or more. In the conductive material, even when the content of the solder particles in 100% by weight of the conductive material is 20% by weight or more and 50% by weight or less, the solder can be more efficiently placed on the electrode. In the conductive material, the content of the solder particles in 100% by weight of the conductive material may be 85% by weight or more, 90% by weight or more, and 95% by weight or less. In the conductive material, even when the content of the solder particles in 100% by weight of the conductive material is 85% by weight or more and 95% by weight or less, the solder can be more efficiently placed on the electrode.

From the viewpoint of further enhancing the conduction reliability when a line (L) of a portion where the electrode is formed is 50 or more and less than 150 μm, the content of the solder particles in 100% by weight of the conductive material is preferably 20% by weight or more, more preferably 30% by weight or more, and preferably 55% by weight or less, more preferably 45% by weight or less.

From the viewpoint of further enhancing the conduction reliability when a space (S) of a portion without the electrode is 50 μm or more and less than 150 μm, the content of the solder particles in 100% by weight of the conductive material is preferably 30% by weight or more, more preferably 40% by weight or more, and preferably 70% by weight or less, more preferably 60% by weight or less.

From the viewpoint of further enhancing the conduction reliability when the line (L) of a portion where the electrode is formed is 150 μm or more and less than 1000 μm, the content of the solder particles in 100% by weight of the conductive material is preferably 30% by weight or more, more preferably 40% by weight or more, and preferably 70% by weight or less, more preferably 60% y weight or less.

From the viewpoint of further enhancing the conduction reliability when a space (S) of a portion without the electrode is 150 μm or more and less than 1000 μm, the content of the solder particles in 100% by weight of the conductive material is preferably 30% by weight or more, more preferably 40% by weight or more, and preferably 70% by weight or less, more preferably 60% by weight or less.

(Thermosetting Compound)

The conductive material contains a thermosetting compound. The thermosetting compound is a compound curable by heating. Examples of the thermosetting compound include oxetane compounds, epoxy compounds, episulfide compounds, (meth)acrylic compounds, phenol compounds, amino compounds, unsaturated polyester compounds, polyurethane compounds, silicone compounds and polyimide compounds. From the viewpoint of further improving the curability and viscosity of the conductive material and further enhancing the connection reliability, the thermosetting compound is preferably an epoxy compound or an episulfide compound. One kind of the thermosetting compound may be used alone, and two or more kinds thereof may be used in combination.

From the viewpoint of more efficiently placing the solder on the electrode, the thermosetting compound preferably contains a thermosetting compound having a polyether skeleton.

Examples of the thermosetting compound having a polyether skeleton include a compound having glycidyl ether groups at both ends of an alkyl chain with 3 to 12 carbon atoms and a polyether type epoxy compound having a polyether skeleton with 2 to 4 carbon atoms and having a structural unit in which 2 to 10 polyether skeletons are continuously bonded.

From the viewpoint of further enhancing heat resistance of a cured product of the conductive material and further lowering a dielectric constant of the cured product of the conductive material, the thermosetting compound preferably includes a thermosetting compound having a triazine skeleton.

Examples of the thermosetting compound having a triazine skeleton include triazine triglycidyl ether, and examples thereof include TEPIC series (TEPIC-G, TEPIC-S, TEPIC-SS, TEPIC-HP, TEPIC-L, TEPIC-PAS, TEPIC-VL, TEPIC-UC).

Examples of the epoxy compound include an aromatic epoxy compound. The epoxy compound is preferably a crystalline epoxy compound such as a resorcinol type epoxy compound, a naphthalene type epoxy compound, a biphenyl type epoxy compound, or a benzophenone type epoxy compound. The epoxy compound is solid at room temperature (23° C.) and is preferably an epoxy compound having a melting temperature of not more than the melting point of the solder. The melting temperature is preferably 100° C. or less, more preferably 80° C. or less, and preferably 40° C. or more. When the above preferable epoxy compound is used, the viscosity is high at the time of laminating the connection object member, and when acceleration is applied by shocks of moving or the like, positional displacement between the first connection object member and the second connection object member can be suppressed. Further, by using the preferred epoxy compound, the viscosity of the conductive material can be greatly lowered by heat at the time of curing, and aggregation of the solder can proceed efficiently.

From the viewpoint of more efficiently placing the solder on the electrode, the thermosetting compound preferably contains a thermosetting compound in a liquid state at 25° C. Examples of the thermosetting compound in a liquid state at 25° C. include epoxy compounds and episulfide compounds.

The content of the thermosetting compound in 100% by weight of the conductive material is preferably 20% by weight or more, more preferably 40% by weight or more, further preferably 50% by weight or more, and preferably 99% by weight or less, more preferably 98% by weight or less, further preferably 90% by weight or less, particularly preferably 80% by weight or less. When the content of the thermosetting compound is not less than the above lower limit and not more than the above upper limit, it is possible to more efficiently place the solder on the electrode, further suppress positional displacement between the electrodes, and further increase the conduction reliability between the electrodes. From the viewpoint of further increasing the impact resistance, it is more preferable as content of the thermosetting compound is larger.

(Thermosetting Agent)

The conductive material preferably contains a thermosetting agent. The conductive material preferably contains a thermosetting agent together with the thermosetting compound. The thermosetting agent thermally cures the thermosetting compound. Examples of the thermosetting agent include an imidazole curing agent, a phenol curing agent, a thiol curing agent, an amine curing agent, an anhydride curing agent, a thermal cationic curing agent, and a thermal radical generator. One kind of the thermosetting agents may be used alone, and two or more kinds thereof may be used in combination.

From the viewpoint of enabling the conductive material to be more quickly curable at a low temperature, the thermosetting agent is preferably an imidazole curing agent, a thiol curing agent, or an amine curing agent. From the viewpoint of enhancing storage stability when the thermosetting compound and the thermosetting agent are mixed, the thermosetting agent is preferably a latent curing agent. The latent curing agent is preferably a latent imidazole curing agent, a latent thiol curing agent or a latent amine curing agent. The thermosetting agent may be coated with a polymeric substance such as polyurethane resin or polyester resin.

The imidazole curing agent is not particularly limited. Examples of the imidazole curing agent include 2-methylimidazole, 2-ethyl-4-methylimidazole, 1-cyanoethyl-2-phenylimidazole, 1-cyanoethyl-2-phenylimidazolium trimellitate, 2,4-diamino-6-[2′-methylimidazolyl-(1′)]-ethyl-s-triazine, and 2,4-diamino-6-[2′-methylimidazolyl-(1′)]-ethyl-s-triazine isocyanuric acid adduct.

The thiol curing agent is not particularly limited. Examples of the thiol curing agent include trimethylolpropane tris-3-mercaptopropionate, pentaerythritol tetrakis-3-mercaptopropionate and dipentaerythritol hexa-3-mercaptopropionate.

The amine curing agent is not particularly limited. Examples of the amine curing agent include hexamethylenediamine, octamethylenediamine, decamethylenediamine, 3,9-bis(3-aminopropyl)-2,4,8,10-tetraspiro[5.5]undecane, bis(4-aminocyclohexyl)methane, metaphenylenediamine and diaminodiphenyl sulfone.

The thermal cationic curing agent is not particularly limited. Examples of the thermal cationic curing agent include iodonium-based cationic curing agents, oxonium-based cationic curing agents and sulfonium-based cationic curing agents. Examples of the iodonium-based cationic curing agent include bis(4-tert-butylphenyl)iodonium hexafluorophosphate. Examples of the oxonium-based cationic curing agent include trimethyloxonium tetrafluoroborate. Examples of the sulfonium-based cationic curing agent include tri-p-tolylsulfonium hexafluorophosphate.

The thermal radical generator is not particularly limited. Examples of the thermal radical generator include azo compounds and organic peroxides. Examples of the azo compound include azobisisobutyronitrile (ABN). Examples of the organic peroxide include di-tert-butyl peroxide and methyl ethyl ketone peroxide.

The reaction initiation temperature of the thermosetting agent is preferably 50° C. or more, more preferably 70° C. or more, further preferably 80° C. or more, and preferably 250° C. or less, more preferably 200° C. or less, further preferably 150° C. or less, particularly preferably 140° C. or less. When the reaction initiation temperature of the thermosetting agent is not less than the above lower limit and not more than the above upper limit, the solder is more efficiently placed on the electrode. The reaction initiation temperature of the thermosetting agent is particularly preferably 80° C. or more and 140° C. or less.

From the viewpoint of more efficiently placing the solder on the electrode, the reaction initiation temperature of the thermosetting agent is preferably higher than the melting point of the solder in the solder particles, more preferably higher by 5° C. or more, further preferably by 10° C. or more, than the melting point of the solder.

The reaction initiation temperature of the thermosetting agent means the temperature at the start of the rising of an exothermic peak in DSC.

The content of the thermosetting agent is not particularly limited. The content of the thermosetting agent is preferably 0.01 parts by weight or more, more preferably 1 parts by weight or more, and preferably 200 parts by weight or less, more preferably 100 parts by weight or less, further preferably 75 parts by weight or less based on 100 parts by weight of the thermosetting compound. When the content of the thermosetting agent is not less than the above lower limit, it is easy to sufficiently cure the thermosetting compound. When content of the thermosetting agent is not more than the above upper limit, excessive acid anhydride thermosetting agent that is not involved in curing, and heat resistance of a cured product is further enhanced.

(Ion Scavenger)

The conductive material preferably contains an ion scavenger. The ion scavenger is preferably an ion scavenger capable of trapping ions in the conductive material, and more preferably an ion scavenger capable of trapping free tin ions in the conductive material. The ion scavenger traps, for example, free tin ions in the conductive material. The ion scavenger is not particularly limited and may be a cation scavenger or amphoteric scavenger. In the conductive material, the ion scavenger is preferably used together with the solder particles and a flux described later. The concentration of free tin ions in the conductive material does not include tin atoms trapped by the ion scavenger.

The ion scavenger is a blended product different from the flux described later. The ion scavenger is a blended product different from a compound having a benzothiazole skeleton or a benzothiazole skeleton described below. The role of the ion scavenger in the conductive material is different from the role of the flux described later and the role of the compound having a benzotriazole skeleton or a benzothiazole skeleton described below. For example, in the conductive material, flux or the like acts on solder particles, so that tin ions may be eluted from the surface of the solder of the solder particles. The eluted tin ions are present as free tin ions in the conductive material and may accelerate curing of the thermosetting compound or the like in the conductive material and thicken the conductive material in some cases. The ion scavenger is blended mainly to trap free tin ions in the conductive material and thereby prevent thickening of the conductive material. The flux is blended mainly to remove oxides present on the surface of the solder of the solder particle, the surface of the electrode, and the like, and to prevent formation of the oxide.

If the amount of flux is increased in order to improve the wettability of the solder, when the ion scavenger is blended in the conductive material, it is possible to further effectively prevent the thickening of the conductive material. As a result, even when the conductive material is left for a certain period of time, the solder can be more efficiently placed on the electrode, and the wettability of the solder can be further improved.

From the viewpoint of more efficiently placing the solder on the electrode and further improving the wettability of the solder even when the conductive material is left for a certain period of time, the ion scavenger preferably contains zirconium, aluminum or magnesium. The ion scavenger may contain any one of zirconium, aluminum and magnesium. Examples of commercially available products of the ion scavenger include “KW-2000” manufactured by Kyowa Chemical Industry Co., Ltd., “IXEPLAS-A1” manufactured by Toagosei Co., Ltd. and “IXEPLAS-A2” manufactured by Toagosei Co., Ltd.

The particle diameter of the ion scavenger is preferably 10 nm or more, more preferably 20 nm or more, and preferably 1000 nm or less, more preferably 500 nm or less. When the particle diameter of the ion scavenger is not less than the above lower limit, it is possible to more effectively prevent the thickening of the conductive material due to the ion scavenger. When the particle diameter of the ion scavenger is not more than the above upper limit, the ion scavenger can be dispersed in the conductive material even better, and free tin ions can be more efficiently trapped in the conductive material.

The particle diameter of the ion scavenger indicates a number average particle diameter. The particle diameter of the ion scavenger is determined by, for example, observing arbitrary 50 ion scavengers with an electron microscope or an optical microscope and calculating an average value of the particle diameters of the ion scavengers, or performing laser diffraction type particle size distribution measurement.

The content of the ion scavenger in 100% by weight of the conductive material is preferably 0.01% by weight or more, more preferably 0.05% by weight or more, and preferably 1% by weight or less, more preferably 0.5% by weight or less. When the content of the ion scavenger is not less than the above lower limit, free tin ions can be more efficiently trapped in the conductive material. When the content of the ion scavenger is not more than the above upper limit, it is possible to more effectively prevent the thickening of the conductive material due to the ion scavenger.

(Compound having Benzotriazole Skeleton or Benzothiazole Skeleton)

The conductive material preferably contains a compound having a benzotriazole skeleton or a benzothiazole skeleton. The conductive material may contain only a compound having a benzotriazole skeleton, may contain only a compound having a benzothiazole skeleton, or may contain both the compound having a benzotriazole skeleton and the compound having a benzothiazole skeleton.

The compound having a benzotriazole skeleton or a benzothiazole skeleton is a blended product different from the flux described later. The compound having a benzotriazole skeleton or a benzothiazole skeleton is a blended product different from the ion scavenger described above. In the conductive material, the role of the compound having a benzotriazole skeleton or a benzothiazole skeleton is different from the role of the flux described later and the role of the ion scavenger described above. The compound having a benzotriazole skeleton or a benzothiazole skeleton is blended mainly to prevent oxidation of the surface of the solder of the solder particles and to prevent elution of metal ions from the surface of the solder of the solder particles. The flux is blended mainly to remove oxides present on the surface of the solder of the solder particle, the surface of the electrode, and the like, and to prevent formation of the oxide. When metal ions are eluted from the surface of the solder of the solder particles, curing of the thermosetting compound may be promoted, and the conductive material may be thickened. In the conductive material in which the compound having a benzotriazole skeleton or a benzothiazole skeleton is blended in the conductive material, it is possible to more effectively prevent the thickening of the conductive material.

Examples of the compound having a benzotriazole skeleton or a benzothiazole skeleton include 2-(2′-hydroxy-5′-methylphenyl)benzotriazole, 2-(2′-hydroxy-3′-tert-butyl-5′-methylphenyl)-5-chlorobenzotriazole, and 2-mercaptobenzothiazole. One kind of the compounds having a benzotriazole skeleton or a benzothiazole skeleton may be used alone, and two or more kinds thereof may be used in combination.

The compound having a benzotriazole skeleton or a benzothiazole skeleton preferably has a thiol group and is more preferably 2-mercaptobenzothiazole cyclohexylamine, a cyclohexylamine salt of 2-mercaptobenzothiazole or 2-mercaptobenzothiazole. When the compound having a benzotriazole skeleton or a benzothiazole skeleton satisfies the above preferable aspect, the solder can be more efficiently placed on the electrode even when the conductive material is left for a certain period of time, and the wettability of the solder can be further improved.

The compound having a benzotriazole skeleton or a benzothiazole skeleton is preferably a primary thiol, more preferably 2-mercaptobenzothiazole cyclohexylamine, a cyclohexylamine salt of 2-mercaptobenzothiazole or 2-mercaptobenzothiazole. When the compound having a benzotriazole skeleton or a benzothiazole skeleton satisfies the above preferable aspect, the solder can be more efficiently placed on the electrode even when the conductive material is left for a certain period of time, and the wettability of the solder can be further improved.

From the viewpoint of more efficiently placing the solder on the electrode and further improving the wettability of the solder even when the conductive material is left for a certain period of time, it is preferable that the compound having a benzotriazole skeleton or a benzothiazole skeleton is attached on the surface of the solder particles. When the compound having a benzotriazole skeleton or a benzothiazole skeleton is attached on the surface of the solder particles, for example, it is preferable that the compound having a benzotriazole skeleton or a benzothiazole skeleton is placed on the surface of the solder particles by a chemical or physical method. Examples of the chemical method include a method of placing the compound having a benzotriazole skeleton or a benzothiazole skeleton on the surface of the solder particles via a chemical bond such as a covalent bond or a coordination bond. Examples of the physical method include a method of placing the compound having a benzotriazole skeleton or a benzothiazole skeleton on the surface of the solder particles via a physical interaction such as van der Waals force.

An area of the surface on which the compound having the benzotriazole skeleton or the benzothiazole skeleton is attached relative to the entire 100% of the surface area of the solder particle is preferably 0.01% or more, more preferably 0.05% or more, and preferably 100% or less, more preferably 5% or less, further preferably 1% or less. When the compound having a benzotriazole skeleton or a benzothiazole skeleton satisfies the above preferable aspect, the solder can be more efficiently placed on the electrode even when the conductive material is left for a certain period of time, and the wettability of the solder can be further improved.

The content of the compound having a benzotriazole skeleton or a benzothiazole skeleton in 100% by weight of the conductive material is preferably 0.01% by weight or more, more preferably 0.05% by weight or more, and preferably 5% by weight or less, more preferably 1% by weight or less. When the content of the compound having a benzotriazole skeleton or a benzothiazole skeleton is not less than the above lower limit and not more than the above upper limit, the solder can be more efficiently placed on the electrode even when the conductive material is left for a certain period of time, and the wettability of the solder can be further improved.

(Flux)

The conductive material preferably contains a flux. By using the flux, the solder can be more effectively placed the electrode. The flux is not particularly limited. The flux does not include the ion scavenger. The flux does not include the compound having a benzotriazole skeleton or a benzothiazole skeleton. As the flux, fluxes that are generally used for solder joint or the like can be used.

Examples of the flux include zinc chloride, mixtures of zinc chloride and an inorganic halide, mixtures of zinc chloride and an inorganic acid, molten salts, phosphoric acid, derivatives of phosphoric acid, organic halides, hydrazine, amine compounds, organic acids and pine resins. One kind of the flux may be used alone, and two or more kinds thereof may be used in combination

Examples of the molten salt include ammonium chloride. Examples of the organic acid include lactic acid, citric acid, stearic acid, glutamic acid and glutamic acid. Examples of the pine resin include an activated pine resin and a non-activated pine resin. The flux is preferably an organic acid having two or more carboxyl groups or a pine resin. The flux may be an organic acid having two or more carboxyl groups or a pine resin. By using the organic acid having two or more carboxyl groups, or the pine resin, the conduction reliability between the electrodes further increases.

Examples of the organic acid having two or more carboxyl groups include succinic acid, glutaric acid, adipic acid, pimelic acid, suberic acid, azelaic acid, and sebacic acid.

Examples of the amine compound include cyclohexylamine, dicyclohexylamine, benzylamine, benzhydrylamine, imidazole, benzimidazole, phenylimidazole, carboxybenzimidazole, and benzotriazole carboxybenzotriazole.

The pine resin is a rosin having abietic acid as a main component. Examples of the rosins include abietic acid and acrylic-modified rosin. The flux is preferably a rosin, and more preferably abietic acid. When this preferable flux is used, the conduction reliability between electrodes further increases.

The melting point (activation temperature) of the flux is preferably 10° C. or more, more preferably 50° C. or more, still more preferably 70° C. or more, further preferably 80° C. or more, and preferably 200° C. or less, more preferably 190° C. or less, still more preferably 160° C. or less, even more preferably 150° C. or less, furthermore preferably 140° C. or less. When the melting point of the flux is not less than the above lower limit and not more than the above upper limit, the flux effect is more effectively exhibited, and the solder is more efficiently placed on the electrode. The melting point (activation temperature) of the flux is preferably 80° C. or more and 190° C. or less. The melting point (activation temperature) of the flux is particularly preferably 80° C. or more and 140° C. or less.

Examples of the flux having a melting point (activation temperature) of 80° C. or more and 190° C. or less include dicarboxylic acids such as succinic acid (melting point 186° C.), glutaric acid (melting point 96° C.), adipic acid (melting point 152° C.), pimelic acid (melting point 104° C.), and suberic acid (melting point 142° C.), benzoic acids (melting point 122° C.), and malic acids (melting point 130° C.)

The boiling point of the flux is preferably 200° C. or less.

From the viewpoint of more efficiently placing the solder on the electrode, the melting point of the flux is preferably higher than the melting point of the solder in the solder particles, more preferably higher by 5° C. or more, further preferably by 10° C. or more, than the melting point of the solder.

From the viewpoint of more efficiently placing the solder on the electrode, the melting point of the flux is preferably higher than the reaction initiation temperature of the thermosetting agent, more preferably higher by 5° C. or more, further preferably by 10° C. or more, than the reaction initiation temperature of the thermosetting agent.

The flux may be dispersed in the conductive material or may be attached on the surface of the solder particles.

Since the melting point of the flux is higher than the melting point of the solder particles, it is possible to efficiently aggregate the solder in an electrode portion. This is due to the fact that, when heat is applied at the time of bonding, when comparing the electrode formed on the connection object member and a portion of the connection object member around the electrode, thermal conductivity of the electrode portion is higher than the thermal conductivity of the connection object member portion around the electrode, so that a temperature rise of the electrode portion is fast. At the time of exceeding the melting point of the solder particles, although the inside of the solder particles dissolves, an oxide film formed on the surface is not removed because the temperature does not reach the melting point (activation temperature) of the flux. In this state, since the temperature of the electrode portion first reaches the melting point (activation temperature) of the flux, the oxide film on the surface of the solder particles preferentially on the electrode is removed, and the solder can be wetted and spread over the surface of the electrode. As a result, it is possible to efficiently aggregate the solder on the electrode.

The content of the flux in 100% by weight of the conductive material is preferably 0.5% by weight or more, and preferably 30% by weight or less, more preferably 25% by weight or less. The conductive material may not contain a flux. When the content of the flux is not less than the above lower limit and not more than the above upper limit, it is more difficult for an oxide film to be formed on the solder particles and the electrode surface, and, in addition, the oxide film formed on the solder particles and the electrode surface can be more effectively removed.

(Insulating Particles)

From the viewpoint of highly precisely controlling an interval between the connection object members connected by the cured product of the conductive material and highly precisely controlling an interval between the connection object members connected by the solder portion, the conductive material preferably contains insulating particles. In the conductive material, the insulating particles may not be attached on the surface of the solder particles. In the conductive material, the insulating particles are preferably present apart from the solder particles.

The particle diameter of the insulating particles is preferably 10 μm or more, more preferably 20 μm or more, further preferably 25 μm or more, and preferably 100 μm or less, more preferably 75 μm or less, further preferably 50 μm or less. When the particle diameter of the insulating particles is not less than the above lower limit and not more than the above upper limit, the interval between the connection object members connected by the cured product of the conductive material and the interval between the connection object members connected by the solder portion are more appropriate.

Examples of the material of the insulating particles include an insulating resin and an insulating inorganic material. Examples of the insulating resin include a polyolefin compound, a (meth)acrylate polymer, a (meth)acrylate copolymer, a block polymer, a thermoplastic resin, a crosslinked product of a thermoplastic resin, a thermosetting resin and a water-soluble resin.

Examples of the polyolefin compound include polyethylene, an ethylene-vinyl acetate copolymer, and an ethylene-acrylate copolymer. Examples of the (meth)acrylate polymer include polymethyl (meth)acrylate, polyethyl (meth)acrylate and polybutyl (meth)acrylate. Examples of the block polymer include polystyrene, styrene-acrylate copolymer, SB type styrene-butadiene block copolymer, SBS type styrene-butadiene block copolymer, and hydrogenated products thereof. Examples of the thermoplastic resin include a vinyl polymer and a vinyl copolymer. Examples of the thermosetting resin include epoxy resin, phenol resin, and melamine resin. Examples of the water-soluble resin include polyvinyl alcohol, polyacrylic acid, polyacrylamide, polyvinyl pyrrolidone, polyethylene oxide, and methyl cellulose. A water-soluble resin is preferable, and polyvinyl alcohol is more preferable.

Examples of the insulating inorganic material include silica and organic-inorganic hybrid particles. The particles formed of the silica are not particularly limited, and examples thereof include particles obtained y hydrolyzing a silicon compound having two or more hydrolyzable alkoxysilyl groups to form crosslinked polymer particles and then performing firing as necessary. Examples of the organic-inorganic hybrid particles include organic-inorganic hybrid particles formed of crosslinked alkoxysilyl polymer and an acrylic resin.

The content of the insulating particles in 100% by weight of the conductive material is preferably 0.1% by weight or more, more preferably 0.5% by weight or more, and preferably 10% by weight or less, more preferably 5% weight or less. The conductive material may not contain the insulating particles. When the content of the insulating particles is not less than the above lower limit and not more than the above upper limit, the interval between the connection object members connected by the cured product of the conductive material and the interval between the connection object members connected by the solder portion are more appropriate.

(Other components)

If necessary, the conductive material may contain various additives such as a coupling agent, a light shielding agent, a reactive diluent, a defoaming agent, a leveling agent, a filler, an extender, a softener, a plasticizer, a polymerization catalyst, a curing catalyst, a colorant, an antioxidant, a thermal stabilizer, a light stabilizer, an ultraviolet absorber, a lubricant, an antistatic agent, and a flame retardant.

(Connection Structure and Method for Producing Connection Structure)

A connection structure according to the present invention includes a first connection object member having at least one first electrode on its surface, a second connection object member having at least one second electrode on its surface, and a connection portion connecting the first connection object member and the second connection object member. In the connection structure according to the present invention, the material of the connection portion is the above-described conductive material. In the connection structure according to the present invention, the connection portion is a cured product of the above-described conductive material. In the connection structure according to the present invention, the connection portion is formed of the above-described conductive material. In the connection structure according to the present invention, the first electrode and the second electrode are electrically connected by a solder portion in the connection portion.

The method for producing a connection structure includes a process of placing the conductive material on the surface of the first connection object member, having at least one first electrode on its surface, with the use of the above-described conductive material. The method for producing a connection structure includes a process of disposing the second connection object member, having at least one second electrode on its surface, on a surface opposite to the first connection object member side of the conductive material such that the first electrode and the second electrode face each other. The method for producing a connection structure includes a process of heating the conductive material to a temperature not less than a melting point of solder in the solder particles to form a connection portion, connecting the first connection object member and the second connection object member, with the conductive material and electrically connecting the first electrode and the second electrode via a solder portion in the connection portion. Preferably, the conductive material is heated to a temperature not less than the curing temperature of the thermosetting compound.

In the connection structure and the method for producing a connection structure according to the present invention, since a specific conductive material is used, the solder particles are likely to gather between the first electrode and the second electrode, and the solder particles can be efficiently placed on the electrode (line). In addition, such a phenomenon that some solder particles are placed in a region (space) where no electrode is formed is suppressed, and the amount of the solder particles placed in the region where no electrode is formed can be considerably reduced. Accordingly, the conduction reliability between the first electrode and the second electrode can be enhanced. In addition, it is possible to prevent electrical connection between electrodes that must not be connected and are adjacent in a lateral direction, and insulation reliability can be enhanced.

In order to efficiently place the solder on the electrode and considerably reduce the amount of the solder placed in the region where no electrode is formed, preferably the conductive material is not a conductive film, and a conductive paste is used.

The thickness of the solder portion between the electrodes is preferably 10 μm or more, more preferably 20 μm or more, and preferably 100 μm or less, more preferably 80 μm or less. A solder wetting area on the surface of the electrode (an area where the solder is in contact in 100% of the exposed area of the electrode) is preferably 50% or more, more preferably 70% or more, and preferably 100% or less.

In the method for producing a connection structure according to the present invention, it is preferable that in a process of disposing the second connection object member and a process of forming the connection portion, no pressure is applied, and the weight of the second connection object member is applied to the conductive material. Further, it is preferable that in the process of disposing the second connection object member and the process of forming the connection portion, a pressurizing pressure exceeding the force of the weight of the second connection object member is not applied to the conductive material. In these cases, uniformity of the solder amount can be further enhanced in a plurality of solder portions. In addition, the thickness of the solder portion can be more effectively increased, and many solder particles are likely to gather between the electrodes, so that the solder can be more efficiently placed on the electrode (line). In addition, such a phenomenon that some solder particles are placed in a region (space) where no electrode is formed is suppressed, and the amount of the solder placed in the region where no electrode is formed can be further reduced. Accordingly, the conduction reliability between the electrodes can be further enhanced. In addition, it is possible to further prevent electrical connection between electrodes that must not be connected and are adjacent in a lateral direction, and insulation reliability can be further enhanced.

If a conductive paste is used, not a conductive film, it becomes easy to adjust the thickness of the connection portion and the solder portion depending on an amount of the conductive paste to be coated. On the other hand, disadvantageously in the case of the conductive film in order to change or adjust the thickness of the connection portion, it is necessary to prepare conductive films of different thicknesses or to prepare a conductive film of a predetermined thickness. In addition, in the conductive film, melt viscosity of the conductive film cannot be sufficiently lowered at the melting temperature of the solder as compared with the conductive paste, and agglomeration of the solder tends to be easily inhibited.

Hereinafter, specific embodiments of the present invention will be described with reference to the drawings.

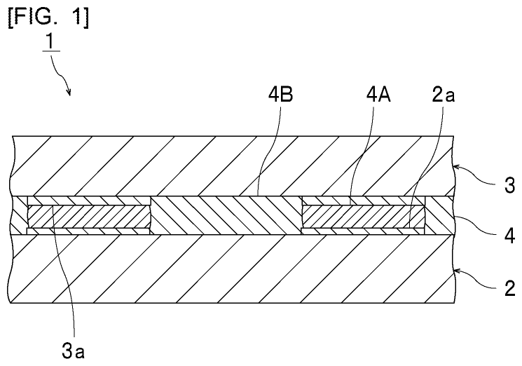

FIG. 1 is a cross-sectional view schematically showing a connection structure obtained using a conductive material according to one embodiment of the present invention.

A connection structure 1 shown in FIG. 1 includes a first connection object member 2, a second connection object member 3, and a connection portion 4 connecting the first connection object member 2 and the second connection object member 3 The connection portion 4 is formed of the above-described conductive material. In the present embodiment, the conductive material contains a thermosetting compound, a thermosetting agent, solder particles and an ion scavenger. In the present embodiment, a conductive paste is used as the conductive material.

The connection portion 4 has a solder portion 4A in which a plurality of solder particles gather and are bonded to each other and a cured product portion 4B in which a thermosetting compound is thermally cured.

The first connection object member 2 has a plurality of first electrodes 2a on its surface (upper surface). The second connection object member 3 has a plurality of second electrodes 3a on its surface (lower surface). The first electrode 2a and the second electrode 3a are electrically connected by the solder portion 4A. Accordingly, the first connection object member 2 and the second connection object member 3 are electrically connected by the solder portion 4A. In the connection portion 4, no solder particle exists in a region (a site of the cured product portion 4B) different from the solder portion 4A gathering between the first electrode 2a and the second electrode 3a. In the region (the site of the cured product portion 4B) different from the solder portion 4A, there is no solder particle away from the solder portion 4A. A small amount of solder particles may exist in the region (the site of the cured product portion 4B) different from the solder portion 4A gathering between the first electrode 2a and the second electrode 3a.

As shown in FIG. 1, in the connection structure 1, a plurality of solder particles gather between the first electrode 2a and the second electrode 3a, and after the plurality of solder particles melt, a melt of the solder particles is wetted and spreads over the surface of the electrode and is then solidified to form the solder portion 4A. Thus, a connection area between the solder portion 4A and the first electrode 2a and a connection area between the solder portion 4A and the second electrode 3a increase. That is, by using the solder particles, the contact area of the solder portion 4A and the first electrode 2a and the contact area of the solder portion 4A and the second electrode 3a are large as compared to a case where a conductive particle with a conductive outer surface formed of a metal such as nickel, gold or copper is used. Thus, the conduction reliability and the connection reliability in the connection structure 1 are enhanced. When flux is contained in the conductive material, the flux is generally gradually deactivated by heating.

In the connection structure 1 shown in FIG. 1, all of the solder portions 4A are located in a region where the first and second electrodes 2a and 3a face each other. In a connection structure 1X of the modified example shown in FIG. 3, only a connection portion 4X differs from the connection structure 1 shown in FIG. 1. The connection portion 4X has a solder portion 4XA and a cured product portion 4XB. As in the connection structure 1X, most of the solder portion 4XA is located in a region where the first and second electrodes 2a and 3a face each other, and a portion of the solder portion 4XA may protrude laterally from the region where the first and second electrodes 2a and 3a face each other. The solder portion 4XA protruding laterally from the region where the first and second electrodes 2a and 3a face each other is a portion of the solder portion 4XA and is not a solder particle away from the solder portion 4XA. In the present embodiment, the amount of solder particles away from the solder portion can be reduced; however, the solder particles away from the solder portion may exist in a cured product portion.

The connection structure 1 can be easily obtained by reducing the use amount of solder particles. The connection structure 1X can be easily obtained by increasing the use amount of solder particles.

In the connection structures 1 and 1X, when viewing a portion where the first electrode 2a and the second electrode 3a face each other in a stacking direction of the first electrode 2a, the connection portions 4 and 4X and the second electrode 3a, it is preferable that the solder portions 4A and 4XA in the connection portions 4 and 4X are placed in 50% or more of 100% of the area of the portion where the first electrode 2a and the second electrode 3a face each other. When the solder portions 4A and 4XA in the connection portions 4 and 4X satisfy the above preferable aspect, the conduction reliability can be further enhanced.

When viewing a portion where the first electrode and the second electrode face each other in a stacking direction of the first electrode, the connection portion, and the second electrode, it is preferable that the solder portion in the connection portion is placed in 50% or more of 100% of the area of the portion where the first electrode and the second electrode face each other. When viewing a portion where the first electrode and the second electrode face each other in a stacking direction of the first electrode, the connection portion, and the second electrode, it is more preferable that the solder portion in the connection portion is placed in 60% or more of 100% of the area of the portion where the first electrode and the second electrode face each other. When viewing a portion where the first electrode and the second electrode face each other in a stacking direction of the first electrode, the connection portion, and the second electrode, it is further preferable that the solder portion in the connection portion is placed in 70% or more of 100% of the area of the portion where the first electrode and the second electrode face each other. When viewing a portion where the first electrode and the second electrode face each other in a stacking direction of the first electrode, the connection portion, and the second electrode, it is particularly preferable that the solder portion in the connection portion is placed in 80% or more of 100% of the area of the portion where the first electrode and the second electrode face each other. When viewing a portion where the first electrode and the second electrode face each other in a stacking direction of the first electrode, connection portion, and the second electrode, it is most preferable that the solder portion in the connection portion is placed in 90% or more of 100% of the area of the portion where the first electrode and the second electrode face each other. When the solder portion in the connection portion satisfies the above preferable aspect, the conduction reliability can be further enhanced.

When viewing a portion where the first electrode and second electrode face each other in a direction orthogonal to the stacking direction of the first electrode, the connection portion, and the second electrode, it is preferable that 60% or more of the solder portion in the connection portion is placed in the portion where the first electrode and the second electrode face each other. When viewing a portion where the first electrode and the second electrode face each other in a direction orthogonal to the stacking direction of the first electrode, the connection portion, and the second electrode, it is more preferable that 70% or more of the solder portion in the connection portion is placed in the portion where the first electrode and the second electrode face each other. When viewing a portion where the first electrode and the second electrode face each other in a direction orthogonal to the stacking direction of the first electrode, the connection portion, and the second electrode, it is further preferable that 90% or more of the solder portion in the connection portion is placed in the portion where the first electrode and the second electrode face each other. When viewing a portion where the first electrode and the second electrode face each other in a direction orthogonal to the stacking direction of the first electrode, the connection portion, and the second electrode, it is particularly preferable that 95% or more of the solder portion in the connection portion is placed in the portion where the first electrode and the second electrode face each other. When viewing a portion where the first electrode and the second electrode face each other in a direction orthogonal to the stacking direction of the first electrode, the connection portion, and the second electrode, it is most preferable that 99% or more of the solder portion in the connection portion is placed in the portion where the first electrode and the second electrode face each other. When the solder portion in the connection portion satisfies the above preferable aspect, the conduction reliability can be further enhanced.

Next, an example of a method for producing the connection structure 1 using the conductive material according to one embodiment of the present invention will be described.

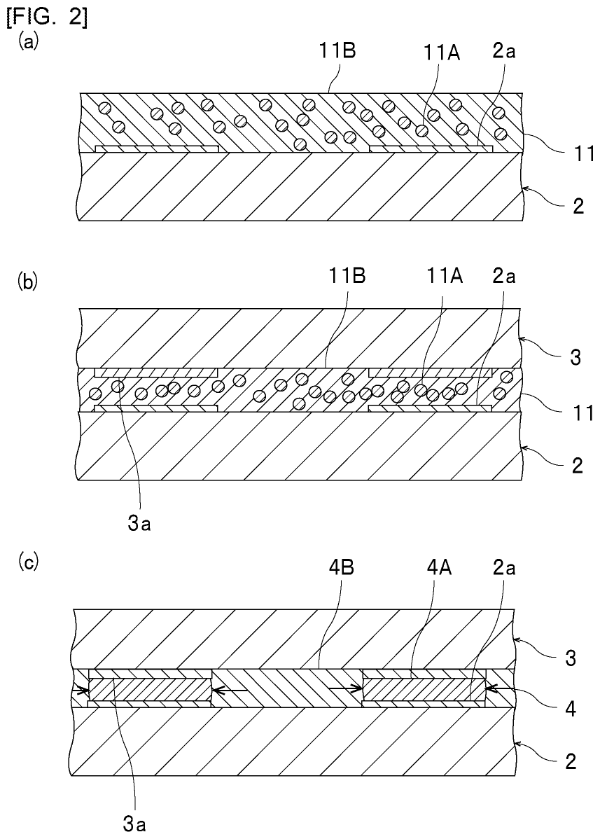

First, the first connection object member 2 having the first electrode 2a on its surface (upper surface) is prepared. Then, as shown in FIG. 2(a), a conductive material 11 containing a thermosetting component 11B and a plurality of solder particles 11A is placed on the surface of the first connection object member 2 (first process). The conductive material 11 used herein contains a thermosetting compound, a thermosetting agent, and an ion scavenger as the thermosetting components 11B.

The conductive material 11 is placed on the surface of the first connection object member 2 on which the first electrode 2a is provided. After the conductive material 11 is placed thereon, the solder particles 11A are arranged both on the first electrode 2a (line) and a region (space) where the first electrode 2a is not formed.

Although the method for placing the conductive material 11 is not particularly limited, application by a dispenser, screen printing, discharge by an inkjet apparatus, and the like can be adopted.

On the other hand, the second connection object member 3 having the second electrode 3a on its surface (lower surface) is prepared. Then, as shown in FIG. 2(b), in the conductive material 11 on the surface of the first connection object member 2, the second connection object member 3 is placed on a surface of the conductive material 11, which is opposite to the first connection object member side (second process). The second connection object member 3 is placed on the surface of the conductive material 11 from the second electrode 3a side. At this time, the first electrode 2a and the second electrode 3a face each other.

Then, the conductive material 11 is heated to a temperature not less than the melting point of the solder particles 11A (third process). Preferably, the conductive material 11 is heated to a temperature not less than the curing temperature of the thermosetting component 11B (thermosetting compound). During this heating, the solder particles 11A existing in the region where no electrode is formed gather between the first electrode 2a and the second electrode 3a (self-aggregation effect). When a conductive paste is used instead of a conductive film, the solder particles 11A more effectively gather between the first electrode 2a and the second electrode 3a. The solder particles 11A melt and are bonded to each other. The thermosetting component 11B is thermally cured. As a result, as shown in FIG. 2(c), the connection portion 4 connecting the first connection object member 2 and the second connection object member 3 is formed by the conductive material 11. The connection portion 4 is formed by the conductive material 11, the solder portion 4A is formed by bonding the plurality of solder particles 11A, and the thermosetting component 11B is thermally cured to form the cured product portion 4B. If the solder particles 11A move sufficiently, it is not necessary to keep temperature constant from a start of movement of the solder particles 11A not located between the first electrode 2a and the second electrode 3a to completion of movement of the solder particles 11A between the first electrode 2a and the second electrode 3a.

In the present embodiment, since the thermosetting component 11B contains the ion scavenger, thickening of the conductive material 11 can be more effectively prevented by trapping free tin ions in the conductive material 11.

In the present embodiment, it is preferable not to perform pressurization in the second process and the third process. In this case, the weight of the second connection object member 3 is added to the conductive material 11. Thus, when the connection portion 4 is formed, the solder particles 11A more effectively gather between the first electrode 2a and the second electrode 3a. If pressurization is performed in at least one of the second process and the third process, there is a high tendency that the action of the solder particles 11A gathering between the first electrode 2a and the second electrode 3a is hindered.

In the present embodiment, since pressurization is not performed, when the second connection object member is superimposed on the first connection object member coated with the conductive material, even in a misalignment state between the first electrode and the second electrode, the misalignment can be corrected, and the first electrode and second electrode can be connected (self-alignment effect). This is because the case where an area where solder between the first electrode and the second electrode is in contact with other components of the conductive material is minimum results in more stabilization in terms of energy of molten solder self-aggregating between the first electrode and the second electrode, so that a force for forming a connection structure with suitable alignment which is a connection structure with the minimum area is applied. In this case, it is desirable that the conductive material is not cured, and the viscosity of components other than the solder particles of the conductive material is sufficiently low at the temperature and time.

Thus, the connection structure 1 shown in FIG. 1 is obtained. The second process and the third process may be performed continuously. After the second process is performed, a stack of the first connection object member 2, the conductive material 11, and the second connection object member 3, to be obtained, is moved to a heating section, and the third process may be performed. In order to perform the heating, the stack may be placed on a heating member, and the stack may be placed in a heated space.

The heating temperature in the third process is preferably 140° C. or more, more preferably 160° C. or more, and preferably 450° C. or less, more preferably 250° C. or less, further preferably 200° C. or less.

Examples of the heating method in the third process include a method of heating the entire connection structure in a reflow oven or an oven to a temperature not less than the melting point of the solder particles and a temperature not less than the curing temperature of the thermosetting compound, and a method of locally heating only the connection portion of the connection structure.

Examples of instruments used for the local heating method include a hot plate, a heat gun for applying hot air, a soldering iron, and an infrared heater.

When local heating is performed using a hot plate, it is preferable that directly under the connection portion, an upper surface of the hot plate is formed with a metal with a high thermal conductivity, and in other portions not preferable to be heated, the upper surface of the hot plate is formed with a material with a low thermal conductivity such as a fluororesin.

The first and second connection object members are not particularly limited. Specific examples of the first and second connection object members include electronic components such as a semiconductor chip, a semiconductor package, an LED chip, an LED package, a capacitor and a diode, and electronic components such as a resin film, a printed board, a flexible printed board, a flexible flat cable, a rigid flexible substrate, a glass epoxy substrate, and a circuit board such as a glass substrate. The first and second connection object members are preferably electronic components.

It is preferable that at least one of the first connection object member and the second connection object member is a resin film, a flexible printed board, a flexible flat cable or a rigid flexible substrate. The second connection object member is preferably a resin film, a flexible printed board, a flexible flat cable or a rigid flexible substrate. The resin film, the flexible printed board, the flexible flat cable and the rigid flexible substrate have high flexibility and relatively light weight. When a conductive film is used to connect such a connection object member, there is a tendency that solder is less likely to gather on the electrode. On the other hand, by using a conductive paste, even if a resin film, a flexible printed board, a flexible flat cable or a rigid flexible substrate is used, solder is efficiently gathered on the electrode, whereby the conduction reliability between the electrodes can be sufficiently enhanced. When a resin film, a flexible printed board, a flexible flat cable or a rigid flexible substrate is used, compared to the case of using other connection object members such as a semiconductor chip, the conduction reliability between the electrodes due to no pressurization can be obtained more effectively.

Examples of the electrode provided on the connection object member include metal electrodes such as a gold electrode, a nickel electrode, a tin electrode, an aluminum electrode, a copper electrode, a molybdenum electrode, a silver electrode, a SUS electrode, and a tungsten electrode. When the connection object member is a flexible printed board, the electrode is preferably a gold electrode, a nickel electrode, a tin electrode, a silver electrode or a copper electrode. When the connection object member is a glass substrate, the electrode is preferably an aluminum electrode, a copper electrode, a molybdenum electrode, a silver electrode or a tungsten electrode. When the electrode is an aluminum electrode, it may be an electrode formed only of aluminum, or may be an electrode with an aluminum layer stacked on the surface of a metal oxide layer. Examples of the material of the metal oxide layer include indium oxide doped with a trivalent metal element and zinc oxide doped with a trivalent metal element. Examples of the trivalent metal element include Sn, Al, and Ga.

In the connection structure according to the present invention, it is preferable that the first electrode and the second electrode are arranged in an area array or a peripheral pattern. When the first electrode and the second electrode are arranged in an area array or a peripheral pattern, the effect of the present invention can be exhibited more effectively. The area array refers to a structure in which electrodes are arranged in a lattice form on the surface on which the electrode of the connection object member is disposed. The peripheral pattern refers to a structure in which electrodes are arranged on an outer peripheral portion of the connection object member. In a structure in which the electrodes are arranged in a comb shape, it is sufficient for the solder to aggregate along a direction perpendicular to the comb, whereas in the area array or the peripheral structure, in the surface where the electrodes are arranged, it is necessary to uniformly aggregate the solder on the entire surface. For this reason, according to the conventional method, the amount of solder tends to be non-uniform, whereas according to the method of the present invention, the effect of the present invention can be exhibited more effectively.

The present invention will be specifically described below by way of Examples and Comparative Examples. The present invention is not limited only to the following examples.

Thermosetting Compound:

Thermosetting compound 1: Resorcinol epoxy compound, “Epolight TDC-LC” manufactured by Kyoeisha Chemical Co., Ltd., epoxy equivalent: 120 g/eq

Thermosetting compound 2: Epoxy compound, “EP-3300” manufactured by ADEKA Corporation, epoxy equivalent: 160 g/eq

Thermosetting Agent:

Latent epoxy thermosetting agent 1: “Fujicure 7000” manufactured by T&K TOKA Corporation

Latent epoxy thermosetting agent 2: “HXA-3922 HP” manufactured by Asahi Kasei E-Materials Corporation

Flux:

Flux 1: “Glutaric acid” manufactured by Wako Pure Chemical Industries, Ltd.

Solder Particle:

Solder particle 1 (SnBi solder particle, melting point: 139° C., “Sn42Bi58” manufactured by Mitsui Mining & Smelting Co., Ltd., particle diameter: 30 μm)

Solder particle 2 (SnBi solder particle, melting point: 139° C., solder particle using as solder particle body solder particles, obtained by sorting “Sn42Bi58” manufactured by Mitsui Mining & Smelting Co., Ltd., and having covering portion formed by electroless plating, particle diameter: 31 μm, thickness of covering portion: 0.5 μm)

(Process for Producing Solder Particles 2)

Solder particles with covering portion formed by electroless plating:

50 g of the solder particle body having a particle diameter of 30 μm was added to 500 g of a 1% by weight citric acid solution to remove an oxide film on the surface of the solder particle body. A solution containing 5 g of silver nitrate and 1000 g of ion exchanged water was prepared, and 50 g of the solder particle body from which an oxide film had been removed was added to and mixed with the prepared solution to obtain a suspension. 30 g of thiomalic acid, 80 g of N-acetylimidazole, and 10 g of sodium hypophosphite were added to and mixed with the obtained suspension to obtain a plating solution. The pH of the resulting plating solution was adjusted to 9 with a 10% by weight ammonia solution, and electroless plating was performed at 25° C. for 20 minutes, whereby solder particles with a covering portion formed by electroless plating were obtained.

Solder particle 3 (SnBi solder particle, melting point: 139° C., solder particle using as solder particle body solder particles, obtained by sorting “Sn42Bi58” manufactured by Mitsui Mining & Smelting Co., Ltd., and having metal portion and covering portion formed y electroless plating, particle diameter: 33 thickness of metal portion: 1 μm, thickness of covering portion: 0.5 μm)

(Process for Producing Solder Particles 3)

Solder particles with metal portion and covering portion formed by electroless plating:

50 g of the solder particle body having a particle diameter of 30 μm was added to 500 g of a 1% by weight citric acid solution to remove an oxide film on the surface of the solder particle body. Palladium was attached by a two-liquid activation method, using 50 g of the solder particle body from which the oxide film had been removed, to obtain a solder particle body with palladium attached on the surface. A solution containing 20 g of nickel sulfate and 1000 g of ion exchanged water was prepared, and 30 a of the solder particle body with palladium attached on the surface was added to and mixed with the prepared solution to obtain a first suspension. 30 g of citric acid, 80 g of sodium hypophosphite, and 10 g of acetic acid were added to and mixed with the obtained first suspension to obtain a first plating solution. The pH of the resulting first plating solution was adjusted to 10 with a 10% by weight ammonia solution, and electroless plating was performed at 60° C. for 20 minutes, whereby a solder particle body with a metal portion formed by electroless plating was obtained.

Then, a solution containing 5 g of silver nitrate and 1000 g of ion exchanged water was prepared, and 50 g of the solder particle body with the metal portion was added to and mixed with the prepared solution to obtain a second suspension. 30 g of succinimide, 80 g of N-acetylimidazole, and 5 g of glyoxylic acid were added to and mixed with the obtained second suspension to obtain a second plating solution The pH of the resulting second plating solution was adjusted to 9 with a 10% by weight ammonia solution, and electroless plating was performed at 20° C. for 20 minutes, whereby solder particles with a metal portion and a covering portion formed by electroless plating were obtained.

Solder particle 4 (SnBi solder particle, melting point: 139° C., solder particle using as solder particle body solder particles, obtained by sorting “Sn42Bi58” manufactured by Mitsui Mining & Smelting Co., Ltd., and having covering portion formed by electroplating, particle diameter: 32 μm, thickness of covering portion: 1 μm)

(Process for Producing Solder Particles 4)

Solder particles with covering portion formed by electroplating:

50 g of the solder particle body having a particle diameter of 30 μm was added to 500 g of a 1% by weight citric acid solution to remove an oxide film on the surface of the solder particle body. A solution containing 5 g of silver nitrate, 1000 g of ion exchanged water, 5 g of 1,3-dibromo-5,5-dimethylhydantoin and 3 g of thiomalic acid was prepared, and 50 g of the solder particle body from which an oxide film had been removed was added to and mixed with the prepared solution to obtain a suspension. Electroplating was performed using the obtained suspension under conditions where anode: platinum, cathode: phosphorus-containing copper, and current density: 1 A/dm², whereby solder particles with a covering portion formed by electroplating were obtained.

Solder particle 5 (SAC particle, melting point: 218° C., “M705” manufactured by Senju Metal industry Co., Ltd., particle diameter: 30 μm)

Solder particle 6 (SnBi solder particle, melting point: 139° C., solder particle using as solder particle body solder particles, obtained by sorting “Sn42Bi58” manufactured by Mitsui Mining & Smelting Co., Ltd., and having covering portion formed by electroplating, particle diameter: 35 μm, thickness of covering portion: 2.5 μm)

(Process for Producing Solder Particles 6)

Solder particles with covering portion formed by electroplating:

50 g of the solder particle body having a particle diameter of 30 μm was added to 500 g of a 1% by weight citric acid solution to remove an oxide film on the surface of the solder particle body. A solution containing 5 g of silver nitrate, 1000 g of ion exchanged water, 5 g of 1,3-dibromo-5,5-dimethylhydantoin and 3 g of thiomalic acid was prepared, and 50 g of the solder particle body from which an oxide film had been removed was added to and mixed with the prepared solution to obtain a suspension. Electroplating was performed using the obtained suspension under conditions where anode: platinum, cathode: phosphorus-containing copper, and current density: 3 A/dm², whereby solder particles with a covering portion formed by electroplating were obtained.

Solder particle 7 (SnBi solder particle, melting point: 139° C., solder particle using as solder particle body solder particles, obtained by sorting “Sn42Bi58” manufactured by Mitsui Mining & Smelting Co., Ltd., and having covering portion formed by electroplating, particle diameter: 33 μm, thickness of covering portion: 1.5 μm)

(Process for Producing Solder Particles 7)

Solder particles with covering portion formed by electroplating:

50 g of the solder particle body having a particle diameter of 30 μm was added to 500 g of a 1% by weight citric acid solution to remove an oxide film on the surface of the solder particle body. A solution containing 5 g of silver nitrate, 1000 g of ion exchanged water, 5 g of 1,3-dibromo-5,5-dimethylhydantoin and 3 g of thiomalic acid was prepared. 50 g of the solder particle body from which an oxide film had been removed was added to and mixed with the prepared solution to obtain a suspension. Electroplating was performed using the obtained suspension under conditions where anode: platinum, cathode: phosphorus-containing copper, and current density: 2 A/dm², whereby solder particles with a covering portion formed by electroplating were obtained.

Particle Diameter of Solder Particle:

The particle diameter of the solder particles was measured by a laser diffraction particle distribution measurement device (“LA-920” manufactured by Horiba, Ltd.).

Thickness of metal portion and thickness of covering portion:

The thickness of the metal portion and the thickness of the covering portion were measured by the method described above.

Content of silver in 100% by weight of solder particles:

The content of silver in 100% by weight of the solder particles was measured by the method described above.

Ion Scavenger:

Ion scavenger 1: “IXEPLAS-A1” manufactured by Toagosei Co., Ltd.

Ion scavenger 2: “IXEPLAS-A2” manufactured by Toagosei Co., Ltd.

Compound having benzotriazole skeleton or benzothiazole skeleton:

Compound 1 having benzothiazole skeleton: “2-mercaptobenzothiazole cyclohexylamine” manufactured by Wako Pure Chemical Industries, Ltd.

Compound 2 having benzothiazole skeleton:

“Sanceler N” manufactured by Sanshin Chemical Industry Co., Ltd., 2-mercaptobenzothiazole

Compound 1 having benzotriazole skeleton: “BT-120” manufactured by Johoku Chemical Co., Ltd., 1,2,3-benzotriazole

### EXAMPLES 1 TO 13 AND COMPARATIVE EXAMPLES 1 to 3

(1) Production of Conductive Material

Components shown in Tables 1 to 3 below were compounded in compounding amounts shown in Tables 1 to 3 to be mixed and defoamed with a planetary stirrer and thus to obtain a conductive material (anisotropic conductive paste).

(2) Production of Connection Structure (Area Array Substrate)

(2-1) Specific Method for Producing Connection Structure Under Condition A

As the second connection object member, there was prepared a semiconductor chip in which copper electrodes with a diameter of 250 μm were arranged at a pitch of 400 μm in an area array on a surface of a semiconductor chip body (size: 5×5 mm, thickness: 0.4 mm), and a passivation film (polyimide, thickness: 5 μm, opening diameter of electrode portion: 200 μm) was formed on the outermost surface. The number of the copper electrodes is 100 in total, i.e., 10 electrodes×10 electrodes, per semiconductor chip.

As the first connection object member, there was prepared a glass epoxy substrate in which copper electrodes were arranged on a surface of a glass epoxy substrate body (size: 20×20 mm, thickness: 1.2 mm, material: FR-4) so as to have the same pattern as the electrodes of the second connection object member, and a solder resist film was formed in a region where no copper electrode was arranged. A step between a surface of the copper electrode and a surface of the solder resist film is 15 μm, and the solder resist film protrudes more than the copper electrode.

The conductive material (anisotropic conductive paste) immediately after production was applied to an upper surface of the glass epoxy substrate to have a thickness of 100 to form an anisotropic conductive paste layer. Then, a semiconductor chip was stacked on an upper surface of the anisotropic conductive paste layer such that the electrodes faced each other. The weight of the semiconductor chip is applied to the anisotropic conductive paste layer. From this state, heating was performed to increase temperature of the anisotropic conductive paste layer to the melting point of solder after 5 seconds from the beginning of temperature rising. In addition, after 15 seconds from the beginning of temperature raising, heating was performed such that the temperature of the anisotropic conductive paste layer increased to 160° C., and the anisotropic conductive paste layer was cured to obtain a connection structure. During heating, pressurization was not performed.

(2-2) Specific Method for Producing Connection Structure Under Condition B

A connection structure (area array substrate) was produced in the same manner as the condition A except that the following changes were made.

Changes from Condition A to Condition B:

The conductive material (anisotropic conductive paste) immediately after production was applied to the upper surface of the glass epoxy substrate to have a thickness of 100 μm to form an anisotropic conductive paste layer, and then the anisotropic conductive paste layer was left for 6 hours in an environment of 25° C. and a humidity of 50%. After leaving, a semiconductor chip was stacked on the upper surface of the anisotropic conductive paste layer such that the electrodes faced each other.

(Evaluation)

(1) Viscosity (η25) of conductive material (anisotropic conductive paste) at 25° C.

The viscosity (η25) at 25° C. of the conductive material (anisotropic conductive paste) immediately after production was measured under conditions of 25° C. and 5 rpm using an E-type viscometer (“TVE22L” manufactured by Toki Sangyo Co., Ltd.). η25 was assessed according to the following criteria.

### [Assessment Criteria for η25]

Δ: η25 is less than 20 Pa·s

◯: η25 is 20 Pa·s or more and 600 Pa·s or less

×: η25 exceeds 600 Pa·s

(2) Viscosity (ηmp) of Conductive Material (Anisotropic Conductive Paste) at Melting Point of Solder Particles

The conductive material (anisotropic conductive paste) immediately after production was measured using STRESSTECH (manufactured by REOLOGICA Instruments AB) under conditions of a strain control of 1 rad, a frequency of 1 Hz, a temperature rising rate of 20° C./min, and a measurement temperature range of 40° C. to the melting point of the solder particles. In this measurement, the viscosity at the melting point of the solder particles was read and taken as the viscosity (ηmp) of the conductive material (anisotropic conductive paste) at the melting point of the solder particles. ηmp was assessed according to the following criteria.

[Assessment Criteria for ηmp]

Δ: ηmp is less than 0.1 Pa·s

◯: ηmp is 0.1 Pa·s or more and 5 Pa·s or less

×: ηmp exceeds 5 Pa·s

(3) Storage Stability

A viscosity (η1) at 25° C. of the conductive material (anisotropic conductive paste) immediately after production was measured under conditions of 25° C. and 5 rpm using an E-type viscometer (“TVE22L” manufactured by Toki Sangyo Co., Ltd.). On the other hand, a viscosity (η2) at 25° C. of the conductive material (anisotropic conductive paste) after being left to stand at 25° C. and a humidity of 50% for 3 days was measured in the same manner as 1. The storage stability was assessed according to the following criteria.

### [Assessment Criteria for Storage Stability]

◯: η2/η1 is less than 2

Δ: η2/η1 is 2 or more and less than 3

×: η2/η1 is 3 or more

(4) Solder Wettability

The conductive material (anisotropic conductive paste) after being left to stand at 25° C. and a humidity of 50% for 3 days, that is, the conductive material used for the evaluation of (3) was provided. The wettability of solder was evaluated using those conductive materials (anisotropic conductive paste). The solder wettability was evaluated as follows. The solder wettability was assessed according to the following criteria.

Evaluation Method of Solder Wettability:

2 mg of a conductive material (anisotropic conductive paste) was applied on a gold electrode with a surface area of 8 mm² with a 2-mmφ mask and heated with a hot plate at 170° C. for 10 minutes. Thereafter, a ratio of a solder wetting area (the area where the solder is in contact with the surface of the gold electrode) to the gold electrode was calculated by image analysis.

### [Assessment Criteria for Solder Wettability]

◯: The ratio of the solder wetting area to the gold electrode is 70% or more

Δ: The ratio of the solder wetting area to the gold electrode is 40% or more and less than 70%

×: The ratio of the solder wetting area to the gold electrode is less than 40%

(5) Placement Accuracy of Solder on Electrode

In the connection structure obtained under the condition A and the condition B, when viewing a portion where the first electrode and the second electrode faced each other in the stacking direction of the first electrode, the connection portion and the second electrode, a ratio X of an area where the solder portion in the connection portion was placed relative to 100% of the area of the portion where the first electrode and the second electrode faced each other was evaluated. The placement accuracy of the solder on the electrode was assessed according to the following criteria.

### [Assessment Criteria for Placement Accuracy of Solder on Electrode]

◯◯: The ratio X is 70% or more

◯: The ratio X is 60% or more and less than 70%

Δ: The ratio X is 50% or more and less than 60%

×: The ratio X is less than 50%

(6) Conduction Reliability Between Upper and Lower Electrodes

In the connection structures (n=15) obtained under condition A and the condition B, each connection resistance per connecting place between upper and lower electrodes was measured by a four-terminal method. An average value of the connection resistance was calculated. From the relationship of voltage=current×resistance, the connection resistance can be obtained by measuring the voltage when a constant current flows. The conduction reliability was assessed according to the following criteria.

[Assessment Criteria for Conduction Reliability]

◯◯: The average value of connection resistances is 50 mΩ or less

◯: The average value of connection resistances is more than 50 mΩ and 70 mΩ or less

Δ: The average value of connection resistances is more than 70 mΩ and 100 mΩ or less

×: The average value of connection resistances is more than 100 mΩ, or a connection failure occurs

(7) Insulation Reliability Between Adjacent Electrodes

After the connection structures (n=15) obtained under the condition A and the condition B were left for 100 hours in an atmosphere of 85° C. and a humidity of 85%, 5 V was applied between adjacent electrodes, and the resistance value was measured at 25 places. The insulation reliability was assessed according to the following criteria.

### [Assessment Criteria for Insulation Reliability]

◯◯: The average value of connection resistance is 10⁷Ω or more

◯: The average value of connection resistances is 10⁶Ω or more and less than 10⁷Ω

Δ: The average value of connection resistances is 10⁵Ω or more and less than 10⁶Ω

×: The average value of connection resistances is less than 10⁵Ω

(8) Concentration of Free Tin Ions in Conductive Material

The conductive material (anisotropic conductive paste) after being left to stand at 25° C. and a humidity of 50% for 3 days, that is, the conductive material used for the evaluation of (3) was provided. The conductive material (anisotropic conductive paste) was dissolved in methyl isobutyl ketone and filtered using a 0.2 μm PTFE filter to obtain a filtrate. The obtained filtrate was analyzed using a high-frequency inductively coupled plasma emission spectrometer (“ICP-AES” manufactured by Horiba, Ltd.) to measure the concentration of free tin ions in the conductive material. The free tin ion concentration was assessed according to the following criteria.

### [Assessment Criteria for Free Tin Ion Concentration]

◯: The concentration of free tin ions in the conductive material is less than 50 ppm

Δ: The concentration of free tin ions in the conductive material is 50 ppm or more and 100 ppm or less

×: The concentration of free tin ions in the conductive material exceeds 100 ppm

(9) Impact Resistance

The connection structures used for the evaluation of (6) were prepared. Those connection structures were dropped from the position of 70 cm in height, and the impact resistance was evaluated by confirming the conduction reliability in the same manner as in the evaluation of (6). The impact resistance was assessed according to the following criteria from a rate of increase in the resistance value from the average value of the connection resistances obtained in the evaluation of (6). Evaluations of (9) Impact resistance were performed only on Examples 9 to 13 and Comparative Example 3.

### [Assessment Criteria for Impact Resistance]

◯◯: The rate of increase in the resistance value from the average value of the connection resistances is 20% or less

◯: The rate of increase in the resistance value from the average value of the connection resistances exceeds 20% and is 35% or less

Δ: The rate of increase in the resistance value from the average value of the connection resistances exceeds 35% and is 50% or less

×: The rate of increase in the resistance value from the average value of the connection resistances exceeds 50%

(10) Coverage

With respect to the obtained solder particles, a surface area (coverage) of the surface of the solder particle body covered with the covering portion relative to the entire 100% of the surface area of the solder particle body was calculated. The coverage was calculated by performing SEM-EDX analysis on the obtained solder particles to perform Ag mapping and performing image analysis.

The results are shown in the following Tables 1 to 3.

TABLE 1

| | | | | | | Comparative |
|---|---|---|---|---|---|---|
| | | | Example 1 | Example 2 | Example 3 | Example 1 |
| Compound component | Thermosetting compound | Thermosetting compound 1 | 6 | 6 | 6 | 6 |
| (part(s) by weight) | | Thermosetting compound 2 | 20 | 20 | 20 | 20 |
| | Thermosetting agent | Latent epoxy thermosetting agent 1 | 0.8 | 0.8 | 0.8 | 0.8 |
| | | Latent epoxy thermosetting agent 2 | 1.5 | 1.5 | 1.5 | 1.5 |
| | Flux | Flux 1 | 1 | 1 | 1 | 1 |
| | Solder particle | Solder particle 1 | 50 | 50 | 50 | 50 |
| | | Solder particle 2 | | | | |
| | | Solder particle 3 | | | | |
| | | Solder particle 4 | | | | |
| | | Solder particle 5 | | | | |
| | | Solder particle 6 | | | | |
| | | Solder particle 7 | | | | |
| | Ion scavenger | Ion scavenger 1 | 0.01 | 1 | | |
| | | Ion scavenger 2 | | | 1 | |
| | Compound having | Compound 1 having benzothiazole skeleton | | | | |
| | benzotriazole skeleton or | Compound 2 having benzothiazole skeleton | | | | |
| | benzothiazole skeleton | Compound 1 having benzotriazole skeleton | | | | |

| Content of solder particles in 100% by weight of conductive material (wt %) | | 63 | 62 | 62 | 63 |
|---|---|---|---|---|---|
| Content of silver in 100% by weight of solder particles (wt %) | | 0 | 0 | 0 | 0 |
| Evaluation | (1) Viscosity (η25) of conductive material at 25° C. | ∘ | ∘ | ∘ | ∘ |
| | (2) Viscosity (ηmp) of conductive material at melting point of solder | ∘ | ∘ | ∘ | ∘ |
| | particles | | | | |
| | (3) Storage stability (η2/η1) | Δ | ∘ | ∘ | x |
| | (4) Solder wettability | ∘ | ∘ | ∘ | x |
| | (5) Placement accuracy of solder on electrode (condition A) | ∘∘ | ∘ | ∘ | Δ |
| | (5) Placement accuracy of solder on electrode (condition B) | ∘∘ | ∘ | ∘ | x |
| | (6) Conduction reliability between upper and lower electrodes | ∘∘ | ∘ | ∘ | ∘ |
| | (condition A) | | | | |
| | (6) Conduction reliability between upper and lower electrodes | ∘∘ | ∘ | ∘ | Δ |
| | (condition B) | | | | |
| | (7) Insulation reliability between adjacent electrodes (condition A) | ∘∘ | ∘ | ∘ | ∘ |
| | (7) insulation reliability between adjacent electrodes (condition B) | ∘∘ | ∘ | ∘ | ∘ |
| | (8) Concentration of free tin ions in conductive material (ppm) | 80 | 45 | 45 | 150 |
| | (8) Concentration of free tin ions in conductive material | Δ | ∘ | ∘ | x |
| | (10) Coverage (%) | 0 | 0 | 0 | 0 |

TABLE 2

| | | | Example | Example | Example | Example | Example | Comparative |
|---|---|---|---|---|---|---|---|---|
| | | | 4 | 5 | 6 | 7 | 8 | Example 2 |
| Compound | Thermosetting compound | Thermosetting compound 1 | 6 | 6 | 6 | 6 | 6 | 6 |
| component | | Thermosetting compound 2 | 20 | 20 | 20 | 20 | 20 | 20 |
| (part(s) by weight) | Thermosetting agent | Latent epoxy thermosetting agent 1 | 0.8 | 0.8 | 0.8 | 0.8 | 0.8 | 0.8 |
| | | Latent epoxy thermosetting agent 2 | 1.5 | 1.5 | 1.5 | 1.5 | 1.5 | 1.5 |
| | Flux | Flux 1 | 1 | 1 | 1 | 1 | 1 | 1 |
| | Solder particle | Solder particle 1 | 50 | 50 | 50 | 50 | 50 | 200 |
| | | Solder particle 2 | | | | | | |
| | | Solder particle 3 | | | | | | |
| | | Solder particle 4 | | | | | | |
| | | Solder particle 5 | | | | | | |
| | | Solder particle 6 | | | | | | |
| | | Solder particle 7 | | | | | | |
| | Ion scavenger | Ion scavenger 1 | | | | | | |
| | | Ion scavenger 2 | | | | | | |
| | Compound having | Compound 1 having benzothiazole skeleton | 0.01 | 5 | | | | 5 |
| | benzotriazole skeleton or | Compound 2 having benzothiazole skeleton | | | 5 | 10 | | |
| | benzothiazole skeleton | Compound 1 having benzotriazole skeleton | | | | | 5 | |

| Content of solder particles in 100% by weight of conductive material (wt %) | | 63 | 59 | 59 | 56 | 59 | 85 |
|---|---|---|---|---|---|---|---|
| Content of silver in 100% by weight of solder particles (wt %) | | 0 | 0 | 0 | 0 | 0 | 0 |
| Evaluation | (1) Viscosity (η25) of conductive material at 25° C. | ∘ | ∘ | ∘ | ∘ | ∘ | ∘ |
| | (2) Viscosity (ηmp) of conductive material at melting point of solder | ∘ | ∘ | ∘ | ∘ | ∘ | ∘ |
| | particles | | | | | | |
| | (3) Storage stability (η2/η1) | Δ | ∘ | ∘ | ∘ | ∘ | ∘ |
| | (4) Solder wettability | ∘ | ∘ | ∘ | ∘ | ∘ | ∘ |
| | (5) Placement accuracy of solder on electrode (condition A) | ∘∘ | ∘ | ∘ | Δ | ∘ | x |
| | (5) Placement accuracy of solder on electrode (condition B) | ∘∘ | ∘ | ∘ | Δ | ∘ | x |
| | (6) Conduction reliability between upper and lower electrodes | ∘∘ | ∘ | ∘ | ∘ | ∘ | ∘ |
| | (condition A) | | | | | | |
| | (6) Conduction reliability between upper and lower electrodes | ∘∘ | ∘ | ∘ | ∘ | ∘ | ∘ |
| | (condition B) | | | | | | |
| | (7) Insulation reliability between adjacent electrodes (condition A) | ∘∘ | ∘ | ∘ | ∘ | ∘ | x |
| | (7) insulation reliability between adjacent electrodes (condition B) | ∘∘ | ∘ | ∘ | ∘ | ∘ | x |
| | (8) Concentration of free tin ions in conductive material (ppm) | 85 | 90 | 85 | 80 | 90 | 200 |
| | (8) Concentration of free tin ions in conductive material | Δ | Δ | Δ | Δ | Δ | x |
| | (10) Coverage (%) | 0 | 0 | 0 | 0 | 0 | 0 |

TABLE 3

| | | | Example | Example | Example | Example | Example | Comparative |
|---|---|---|---|---|---|---|---|---|
| | | | 9 | 10 | 11 | 12 | 13 | Example 3 |
| Compound | Thermosetting compound | Thermosetting compound 1 | 5 | 5 | 5 | 5 | 5 | 5 |
| component | | Thermosetting compound 2 | 15 | 15 | 15 | 15 | 15 | 15 |
| (part(s) by weight) | Thermosetting agent | Latent epoxy thermosetting agent 1 | 0.5 | 0.5 | 0.5 | 0.5 | 0.5 | 0.5 |
| | | Latent epoxy thermosetting agent 2 | 1.5 | 1.5 | 1.5 | 1.5 | 1.5 | 1.5 |
| | Flux | Flux 1 | 1 | 1 | 1 | 1 | 1 | 1 |
| | Solder particle | Solder particle 1 | | | | | | |
| | | Solder particle 2 | 50 | | | | | |
| | | Solder particle 3 | | 50 | | | | |
| | | Solder particle 4 | | | 50 | | | |
| | | Solder particle 5 | | | | | | 50 |
| | | Solder particle 6 | | | | | 50 | |
| | | Solder particle 7 | | | | 50 | | |
| | Ion scavenger | Ion scavenger 1 | | | | | | |
| | | Ion scavenger 2 | | | | | | |
| | Compound having | Compound 1 having benzothiazole skeleton | | | | | | |
| | benzotriazole skeleton or | Compound 2 having benzothiazole skeleton | | | | | | |
| | benzothiazole skeleton | Compound 1 having benzotriazole skeleton | | | | | | |

| Content of solder particles in 100% by weight of conductive material (wt %) | | 68 | 68 | 68 | 68 | 68 | 68 |
|---|---|---|---|---|---|---|---|
| Content of silver in 100% by weight of solder particles (wt %) | | 5 | 5 | 11 | 20 | 25 | 0 |
| Evaluation | (1) Viscosity (η25) of conductive material at 25° C. | ∘ | ∘ | ∘ | ∘ | ∘ | ∘ |
| | (2) Viscosity (ηmp) of conductive material at melting point of solder | ∘ | ∘ | ∘ | ∘ | ∘ | ∘ |
| | particles | | | | | | |
| | (3) Storage stability (η2/η1) | ∘ | ∘ | ∘ | ∘ | Δ | x |
| | (4) Solder wettability | ∘ | ∘ | ∘ | ∘ | Δ | x |
| | (5) Placement accuracy of solder on electrode (condition A) | ∘∘ | ∘∘ | ∘ | Δ | ∘ | ∘ |
| | (5) Placement accuracy of solder on electrode (condition B) | ∘∘ | ∘∘ | ∘ | Δ | ∘ | ∘ |
| | (6) Conduction reliability between upper and lower electrodes | ∘∘ | ∘∘ | ∘ | ∘ | ∘ | ∘ |
| | (condition A) | | | | | | |
| | (6) Conduction reliability between upper and lower electrodes | ∘∘ | ∘∘ | ∘ | ∘ | ∘ | ∘ |
| | (condition B) | | | | | | |
| | (7) Insulation reliability between adjacent electrodes (condition A) | ∘∘ | ∘∘ | ∘ | ∘ | Δ | x |
| | (7) insulation reliability between adjacent electrodes (condition B) | ∘∘ | ∘∘ | ∘ | ∘ | Δ | x |
| | (8) Concentration of free tin ions in conductive material (ppm) | 80 | 85 | 90 | 85 | 85 | 180 |
| | (8) Concentration of free tin ions in conductive material | Δ | Δ | Δ | Δ | Δ | x |
| | (9) Impact resistance (condition A) | ∘∘ | ∘∘ | ∘∘ | ∘∘ | Δ | x |
| | (9) Impact resistance (condition B) | ∘∘ | ∘∘ | ∘∘ | ∘∘ | Δ | x |
| | (10) Coverage (%) | 81 | 85 | 84 | 92 | 90 | 0 |

The same tendency was observed even when using a flexible printed board, a resin film, a flexible flat cable and a rigid flexible substrate.

### EXPLANATION OF SYMBOLS

1, 1X: Connection structure

2: First connection object member

2a: First electrode

3: Second connection object member

3a: Second electrode

4, 4X: Connection portion

4A, 4XA: Solder portion

4B, 4XB: Cured product portion

11: Conductive material

11A: Solder particles

11B: Thermosetting component

1. A conductive material, comprising a thermosetting compound and a plurality of solder particles,
the conductive material having the concentration of free tin ions of 100 ppm or less.

2. The conductive material according to claim 1, further comprising an ion scavenger.

3. The conductive material according to claim 2, wherein the ion scavenger comprises zirconium, aluminum or magnesium.

4. The conductive material according to claim 2, wherein the particle diameter of the ion scavenger is 10 nm or more and 1000 nm or less.

5. The conductive material according to claim 2, wherein the content of the ion scavenger in 100% by weight of the conductive material is 0.01% by weight or more and 1% by weight or less.

6. The conductive material according to claim 1, further comprising a compound having a benzotriazole skeleton or a benzothiazole skeleton, wherein the content of the solder particles in 100% by weight of the conductive material is less than 85% by weight.

7. The conductive material according to claim 6, wherein the compound having a benzotriazole skeleton or a benzothiazole skeleton has a thiol group.

8. The conductive material according to claim 7, wherein the compound having a benzotriazole skeleton or a benzothiazole skeleton is a primary thiol.

9. The conductive material according to claim 6, wherein the compound having a benzotriazole skeleton or a benzothiazole skeleton is attached on the surface of the solder particle.

10. The conductive material according to claim 6, wherein the content of the compound having a benzotriazole skeleton or a benzothiazole skeleton in 100% by weight of the conductive material is 0.01% by weight or more and 5% by weight or less.

11. The conductive material according to claim 1, wherein the solder particle comprises a solder particle body and a covering portion disposed on the surface of the solder particle body.

12. The conductive material according to claim 11, wherein the covering portion comprises an organic compound, an inorganic compound, an organic-inorganic hybrid compound, or a metal.

13. The conductive material according to claim 11, wherein the solder particle body comprises tin and bismuth.

14. The conductive material according to claim 11, wherein the covering portion comprises silver, and
the content of the silver in 100% by weight of the solder particles is 1% by weight or more and 20% by weight or less.

15. The conductive material according to claim 11, wherein a surface area of the surface of the solder particle body covered with the covering portion is 80% or more relative to the entire 100% of the surface area of the solder particle body.

16. The conductive material according to claim 11, wherein the covering portion has a thickness of 0.1 μm or more and 5 μm or less.

17. The conductive material according to claim 11, further comprising a nickel-containing metal portion between an outer surface of the solder particle body and the covering portion.

18. The conductive material according to claim 11, wherein the content of the solder particles in 100% by weight of the conductive material is more than 50% by weight.

19. The conductive material according to claim 1, wherein the thermosetting compound comprises a thermosetting compound having a polyether skeleton.

20. The conductive material according to claim 1, further comprising a flux having a melting point of 50° C. or more and 140° C. or less.

21. The conductive material according to claim 1, wherein the solder particle comprises on its outer surface a carboxyl group or an amino group.

22. The conductive material according to claim 1, wherein the viscosity at 25° C. is 20 Pa·s or more and 600 Pa·s or less.

23. The conductive material according to claim 1, which is a conductive paste.

24. A connection structure comprising:
a first connection object member having at least one first electrode on its surface;
a second connection object member having at least one second electrode on its surface; and
a connection portion connecting the first connection object member and the second connection object member,
the connection portion including the conductive material according to claim 1, and
the first electrode and the second electrode being electrically connected by a solder portion in the connection portion.

25. The connection structure according to claim 24, wherein, when viewing a portion where the first electrode and the second electrode face each other in a stacking direction of the first electrode, the connection portion, and the second electrode, the solder portion in the connection portion is placed in 50% or more of 100% of the area of the portion where the first electrode and the second electrode face each other.
